(19) United States
(12) Patent Application Publication
(10) Pub. No.: US 2016/0365823 A1
(43) Pub. Date: Dec. 15, 2016

(54) SYSTEMS AND METHODS FOR MOUNTING PHOTOVOLTAIC MODULES

(71) Applicant: Alion Energy, Inc., Richmond, CA (US)

(72) Inventors: Adam French, San Francisco, CA (US); Sean Bailey, Emeryville, CA (US); Thomas Goehring, Berkeley, CA (US); Tristan French, El Sobrante, CA (US); Rodney Hans Holland, Novato, CA (US); Graham Maxwell, Rocklin, CA (US); Paul Adriani, Palo Alto, CA (US)

(21) Appl. No.: 15/154,641

(22) Filed: May 13, 2016

Related U.S. Application Data
(60) Provisional application No. 62/163,279, filed on May 18, 2015.
(60) Provisional application No. 62/238,925, filed on Oct. 8, 2015.

(51) Int. Cl. H02S 20/10; H02S 20/30; H02S 30/10

(52) U.S. Cl. CPC H02S 20/10; H02S 30/10; H02S 20/30

(57) ABSTRACT

A system can include first and second stiffeners each coupled to a photovoltaic module, and first, second, third, and fourth legs. First and second joints rotatably couple the first and second legs to the first stiffener; and third and fourth joints rotatably couple the third and fourth legs to the second stiffener. A first crossbrace fixedly couples the first and second legs to one another; and a second crossbrace fixedly couples the third and fourth legs to one another. The first and second legs are rotatable about the first and second joints from a stowed position to an open position supporting the photovoltaic module, and the third and fourth legs are rotatable about the third and fourth joints from a stowed position to an open position supporting the photovoltaic module. At least one of the joints can include an electrical conductor coupled to the respective stiffener and leg.

### CROSS-REFERENCE TO RELATED APPLICATIONS

This application claims the benefit of the following applications, the entire contents of each of which is incorporated herein by reference:

U.S. Provisional Application No. 62/163,279, filed May 18, 2015 and entitled “Systems and Methods for Mounting Photovoltaic Modules,” and

U.S. Provisional Application No. 62/238,925, filed Oct. 8, 2015 and entitled “Apparatus and Methods for Hinge Pin Grounding.”

### FIELD

This application relates to mounting photovoltaic modules.

### BACKGROUND

The installation of photovoltaic arrays often presents logistical challenges. For example, some conventional mounting systems hold photovoltaic modules (e.g., solar panels) at a fixed tilt toward the equator with a tilt angle from the horizon that is approximately equal to the latitude of the photovoltaic arrays. Often, these mounting systems are assembled by hand in the field from metal components; therefore, assembling these mounting systems usually are expensive and labor intensive. The mounting systems often need to withstand harsh outdoor conditions and mechanical loads for a significant period of time, such as 20 years or more.

Hence, it is desirable to improve techniques for the mounting of PV modules.

### SUMMARY

Embodiments of the present invention provide systems and methods for mounting photovoltaic modules.

Under one aspect, a system is provided for mounting a photovoltaic module. The system can include first and second stiffeners each coupled to the photovoltaic module, and first, second, third, and fourth legs. The system also can include a first joint rotatably coupling the first leg to the first stiffener; a second joint rotatably coupling the second leg to the first stiffener; a third joint rotatably coupling the third leg to the second stiffener; and a fourth joint rotatably coupling the fourth leg to the second stiffener. The system also can include a first crossbrace fixedly coupling the first and second legs to one another; and a second crossbrace fixedly coupling the third and fourth legs to one another. The first and second legs respectively can be rotatable about the first and second joints from a stowed position to an open position supporting the photovoltaic module, and the third and fourth legs respectively can be rotatable about the third and fourth joints from a stowed position to an open position supporting the photovoltaic module.

Optionally, when the first, second, third, and fourth legs respectively are in the stowed positions, the first, second, third, and fourth legs each are folded flat against a back of the photovoltaic module. Additionally, or alternatively, the photovoltaic module optionally can include a frame, and when the first, second, third, and fourth legs respectively are in the stowed positions, the first, second, third, and fourth legs each fit within the frame. Additionally, or alternatively, when the first and second legs respectively are in the stowed position or in the open position, the first and second legs optionally each extend at an angle of between about 50 degrees and about 90 degrees from the first stiffener, and when the third and fourth legs respectively are in the stowed position or in the open position, the third and fourth legs optionally each extend at an angle of between about 50 degrees and about 90 degrees from the second stiffener.

Additionally, or alternatively, each of the first, second, third, and fourth legs optionally can include a respective foot. The system optionally further can include a concrete ballast including first and second elongated grooves extending parallel to one another and parallel to the concrete ballast. The feet of the first and third legs optionally can be insertable into the first elongated groove and the feet of the second and fourth legs optionally can be insertable into the second elongated groove when the first, second, third, and fourth legs respectively are in the open position. Optionally, the foot of each of the first, second, third, and fourth legs can include a tapered portion of the respective leg. Additionally, or alternatively, the concrete ballast optionally further can include one or more interlocking control joints. Additionally, or alternatively, a plurality of photovoltaic modules optionally can be mounted along the concrete ballast.

Additionally, or alternatively, the system optionally includes adhesive coupling the first and second stiffeners to the photovoltaic module. The adhesive optionally can include silicone adhesive, a first foam pad, and a second foam pad, the first foam pad providing a first space between the first stiffener and the photovoltaic module, the second foam pad providing a second space between the second stiffener and the photovoltaic module, the silicone adhesive can be disposed within the first space and the second space.

Additionally, or alternatively, each of the first, second, third, and fourth joints optionally can include a hinge pin extending through first and second apertures defined through the respective stiffener and extending through third and fourth apertures defined through the respective leg. Optionally, at least one of the first, second, third, and fourth joints optionally further can include an electrical conductor disposed between and coupled to each of the respective stiffener and the respective leg. Additionally, or alternatively the electrical conductor optionally can be routed around the hinge pin. Optionally, the conductor can include a spring that forces the respective leg into the open position. Additionally, or alternatively, the electrical conductor can include a sheet metal strap. Additionally, or alternatively, the electrical conductor can include a wire. Optionally, the hinge pin can include a portion of the wire. Additionally, or alternatively, at least one hinge pin can include a shoulder bolt including a shoulder having a first diameter and a threaded portion having a second diameter that is smaller than the first diameter, each joint further including a nut threaded on the threaded portion of the respective hinge pin, the nut clamping the respective leg against the respective stiffener so as to provide an electrical connection between that leg and that stiffener. Optionally, the nut is sufficiently tightened so as to provide a predetermined amount of torque. Additionally, or alternatively, the system optionally can include threadlocker disposed on the threaded portion of the hinge pin and inhibiting unlocking of the nut.

Additionally, or alternatively, the system can include an electrical conductor including a wire with sufficient stiffness to force the respective leg into the open position.

Additionally, or alternatively, the system optionally further includes an electrical conductor disposed between and coupled to the photovoltaic module and the first stiffener. Optionally, the electrical conductor can be configured to support cables underneath the photovoltaic module.

Additionally, or alternatively, the first stiffener can include one or more tool access holes for accessing the first joint. Additionally, or alternatively, the first stiffener can include a lance bridge for inhibiting rotation of the first leg past a preselected angle.

Under another aspect, a concrete ballast system is provided for supporting a photovoltaic module. The concrete ballast system can include a concrete rail including a plurality of at least partial cuts therethrough so as to provide a plurality of interlocking portions with reduced movement relative to one another.

Optionally, the concrete ballast system includes first and second elongated grooves extending parallel to one another and parallel to the concrete rail. The photovoltaic module can be coupled to first, second, third, and fourth legs each including a foot. The feet of the first and third legs can be insertable into the first elongated groove and the feet of the second and fourth legs can be insertable into the second elongated groove.

Additionally, or alternatively, a plurality of photovoltaic modules can be supported along the concrete rail.

Additionally, or alternatively, the at least partial cuts are between 10% of a thickness of the concrete rail and the entirety of the thickness of the concrete rail.

Under yet another aspect, a system is provided for supporting a photovoltaic module. The system can include a stiffener coupled to the photovoltaic module; a leg; a joint rotatably coupling the leg to the stiffener between a stowed position and an open position; and an electrical member electrically bonding the stiffener and the leg to one another in at least the open position.

Optionally, the joint includes a hinge pin extending through first and second apertures defined through the stiffener and extending through third and fourth apertures defined through the leg. Additionally, or alternatively, the electrical member optionally can include an electrical conductor disposed between and coupled to each of the stiffener and the leg. Additionally, or alternatively, the electrical conductor optionally can be routed around the hinge pin. Additionally, or alternatively, the conductor optionally can include a spring that forces the leg into the open position. Additionally, or alternatively, the electrical conductor optionally can include a sheet metal strap. Additionally, or alternatively, the electrical conductor optionally can include a wire. Additionally, or alternatively, the hinge pin optionally can include a portion of the wire. Additionally, or alternatively, the hinge pin optionally can include a shoulder bolt including a shoulder having a first diameter and a threaded portion having a second diameter that is smaller than the first diameter. Optionally, the electrical member including a nut threaded on the threaded portion of the hinge pin, the nut clamping the leg against the stiffener so as to provide an electrical connection between the leg and the stiffener. Optionally, the nut is sufficiently tightened so as to provide a predetermined amount of torque. Additionally, or alternatively, the system optionally includes threadlocker disposed on the threaded portion of the hinge pin and inhibiting unlocking of the nut.

Additionally, or alternatively, at least a portion of the hinge pin and at least one of the first and second apertures optionally are shaped so as to interlock with one another so as to inhibit rotation of the hinge pin relative to the stiffener. Additionally, or alternatively, the hinge pin and at least one of the first and second apertures optionally are interference fit with one another so as to inhibit rotation of the hinge pin relative to the stiffener. Additionally, or alternatively, the hinge pin and at least one of the first and second apertures optionally are welded to one another so as to inhibit rotation of the hinge pin relative to the stiffener.

Additionally, or alternatively, the electrical conductor optionally can include a wire with sufficient stiffness to force the leg into the open position.

Additionally, or alternatively, the system optionally can include adhesive coupling the first and second stiffeners to the photovoltaic module. Optionally, the adhesive can include silicone adhesive and a foam pad, the foam pad providing a space between the stiffener and the photovoltaic module, and the silicone adhesive can be disposed within the space.

Additionally, or alternatively, the system further includes an electrical conductor disposed between and coupled to the photovoltaic module and the first stiffener. Optionally, the electrical conductor can be configured to support cables underneath the photovoltaic module.

Additionally, or alternatively, the stiffener optionally can include one or more tool access holes for accessing the first joint. Additionally, or alternatively, the stiffener optionally can include a lance bridge for inhibiting rotation of the leg past a preselected angle.

### BRIEF DESCRIPTION OF DRAWINGS

FIGS. 1A-1D schematically illustrate different views of an exemplary system for mounting a photovoltaic module, according to some embodiments.

FIG. 2 schematically illustrates a plan view of grounding paths within an exemplary system for mounting a photovoltaic module, according to some embodiments.

FIG. 3 schematically illustrates an exemplary joint for mechanically and/or electrically bonding a leg to a stiffener within an exemplary system for mounting a photovoltaic module, according to some embodiments.

FIGS. 4A-4B schematically illustrate views of an exemplary joint for mechanically and/or electrically bonding a leg to a stiffener within an exemplary system for mounting a photovoltaic module, according to some embodiments.

FIGS. 5A-5B schematically illustrate views of another exemplary joint for mechanically and/or electrically bonding a leg to a stiffener within an exemplary system for mounting a photovoltaic module, according to some embodiments.

FIGS. 6, 7, 8A-8B, 9, 10, 11A-11B, 12, 13A-13C, 14A-14C, and 15 schematically illustrate views of additional exemplary joints for mechanically and/or electrically bonding a leg to a stiffener within an exemplary system for mounting a photovoltaic module, according to some embodiments.

FIGS. 16A-16E schematically illustrate different views of an exemplary structure for providing bonding and cable management within an exemplary system for mounting a photovoltaic module, according to some embodiments.

FIG. 17A schematically illustrates selected features of an exemplary concrete rail within an exemplary system for mounting a photovoltaic module, according to some embodiments.

FIGS. 17B-17C are plots illustrating selected characteristics of exemplary systems for mounting a photovoltaic module, according to some embodiments.

FIGS. 18A-18B schematically illustrate side views of exemplary system for mounting a photovoltaic module, according to some embodiments.

### DETAILED DESCRIPTION

Embodiments of the present invention provide systems and methods for mounting photovoltaic modules. Illustratively, some aspects of the systems and methods provided herein relate to certain arrangements of stiffeners, legs, and joints for supporting a photovoltaic module. Some aspects of the systems and methods provided herein relate to certain features of concrete ballasts upon which one of more photovoltaic modules can be mounted. Still other aspects of the systems and methods provided herein relate to certain electrical and/or mechanical features of joints between stiffeners and legs for supporting a photovoltaic module. It should be appreciated that any suitable combination of one or more aspects provided herein optionally can be used with one another, but need not necessarily be used with one another. For example, the presently provided arrangements of stiffeners, legs, and joints can be, but need not necessarily be, used in combination with the presently provided concrete ballasts, or in combination with the presently provided electrical and/or mechanical features of the joints, or in combination with both the presently provided concrete ballasts and with the presently provided electrical and/or mechanical features of the joints. As another example, the presently provided concrete ballasts can be, but need not necessarily be, used in combination with the presently provided arrangements of stiffeners, legs, and joints, or in combination with the presently provided electrical and/or mechanical features of the joints, or in combination with both the presently provided arrangements of stiffeners, legs, and joints and the presently provided electrical and/or mechanical features of the joints. As yet another example, the presently provided electrical and/or mechanical features of the joints can be, but need not necessarily be, used in combination with the presently provided concrete ballasts, or with the presently provided arrangements of stiffeners, legs, and joints, or in combination with both the presently provided concrete ballasts and the presently provided arrangements of stiffeners, legs, and joints.

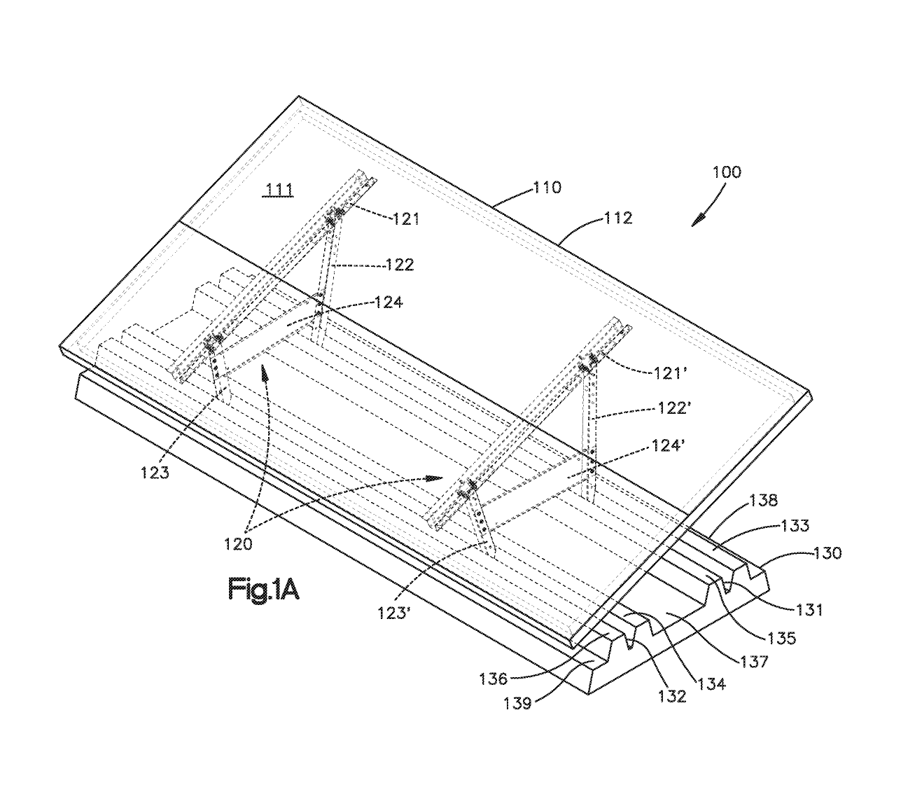

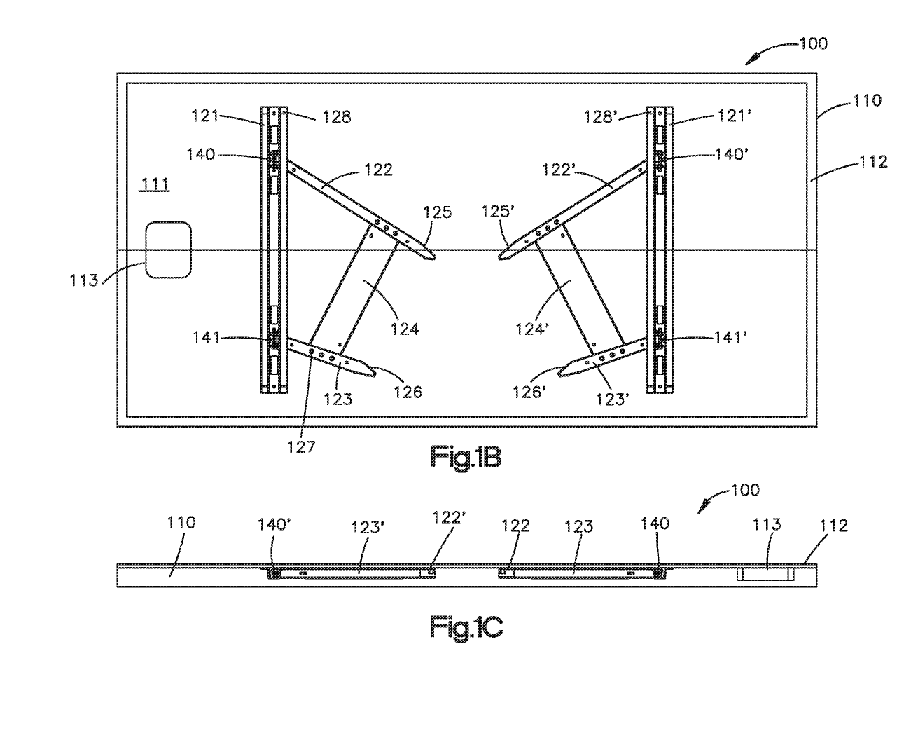

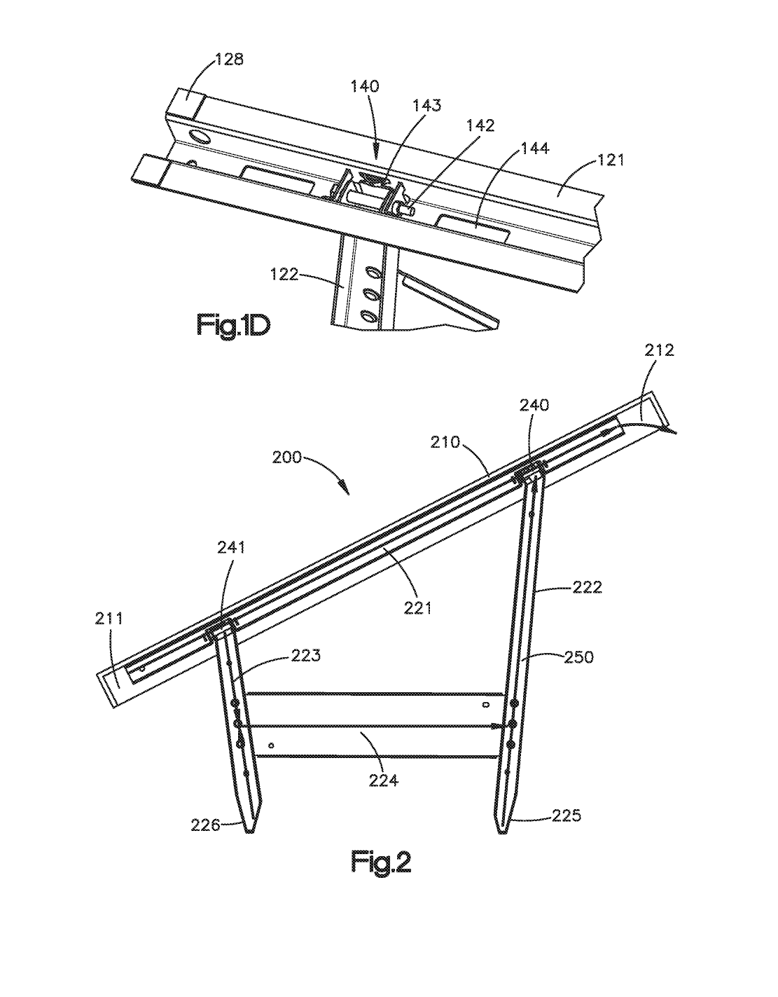

FIGS. 1A-1D schematically illustrate different views of an exemplary system 100 for mounting a photovoltaic module, according to some embodiments. More specifically, FIG. 1A schematically illustrates a perspective view of system 100 in an open configuration, FIG. 1B schematically illustrates a plan view of system 100 in a closed configuration, FIG. 1C schematically illustrates a cross-sectional view of system 100 in a closed configuration, and FIG. 1D schematically illustrates a perspective view of certain features of system 100 in an open configuration. System 100 includes an exemplary arrangement of stiffeners, legs, and joints that optionally can be used in combination with one or more other features such as provided herein. For example, system 100 includes mounting system 120 for mounting photovoltaic module 110, and concrete rail 130 to which mounting system 120 optionally can be coupled.

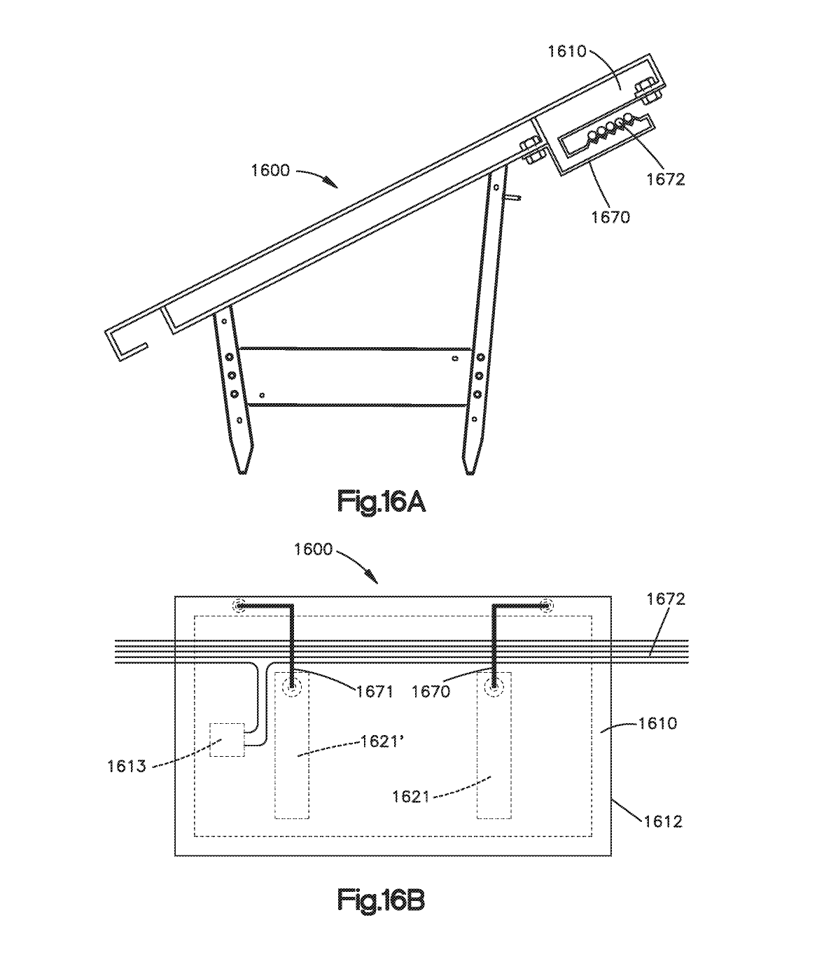

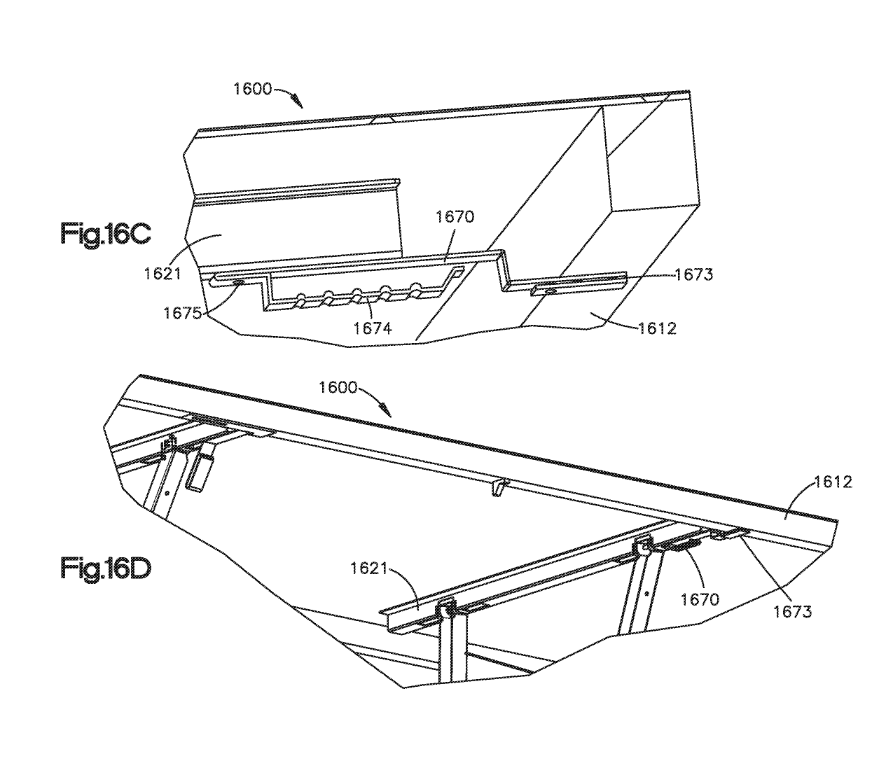

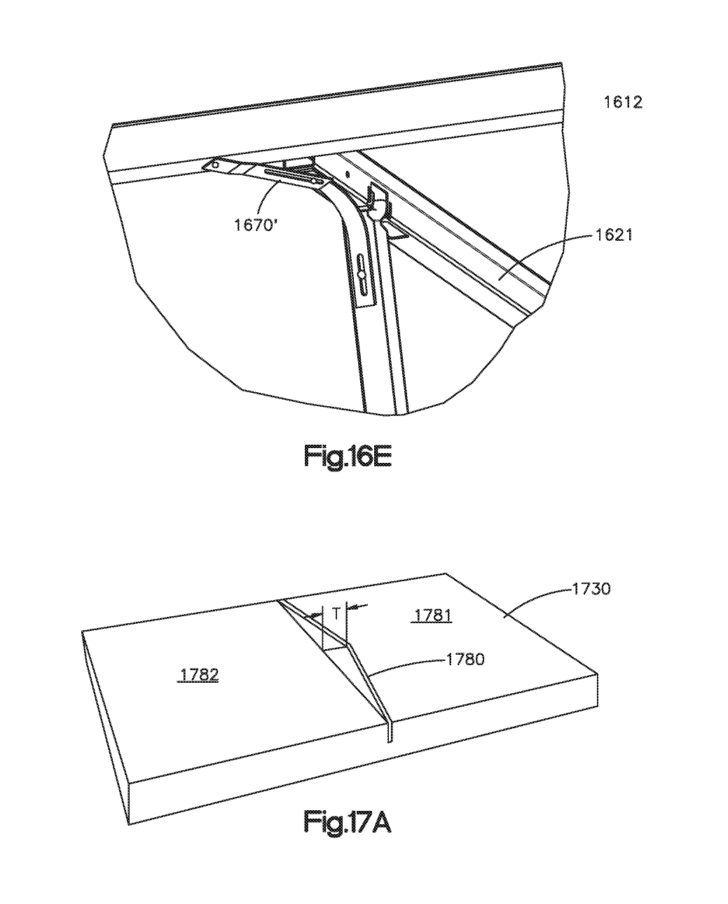

In the non-limiting example illustrated in FIGS. 1A-1D, photovoltaic module 110 can include photovoltaic panel 111 which can be substantially planar, and optionally also can include frame 112 which can extend around the periphery of photovoltaic panel 111. Photovoltaic panel 111 can include any suitable combination of materials and electronics that are suitable for generating electricity responsive to light from the sun, such as well known in the art. Optional frame 112 can be attached to the back of photovoltaic panel 111 using any suitable fastener or adhesive, such as a silicone adhesive. Photovoltaic module 110 optionally can be electrically connected to junction box 113 in a manner such as described herein with reference to FIGS. 16A-16E. Note that photovoltaic module 110 optionally can be, but need not necessarily be, considered to be part of system 100.

In the non-limiting example illustrated in FIGS. 1A-1D, mounting system 120 includes first and second stiffeners 121, 121′ each coupled to photovoltaic module 110. Stiffeners 121, 121′ each can include an elongated structural member including at least one mounting surface coupled to photovoltaic module 110, e.g., optionally including first and second surfaces, such as flanges, separated from one another by a groove. Stiffeners 121, 121′ each can include any suitable material or combination of materials, such as any suitable combination of aluminum, polymer, or steel, e.g., stamped or roll-formed steel. Such steel can be pre-plated, e.g., galvanized, or plain. In one non-limiting example, stiffeners 121, 121′ each include, or consist essentially of, an electrically conductive material such as a metal. Optionally, stiffeners 121, 121′ each can include one or more apertures defined therein, such as for receiving a hinge pin or permitting servicing of a joint or of photovoltaic module 110 in a manner such as described elsewhere herein.

Stiffeners 121, 121′ each can be coupled to photovoltaic module 110 using any suitable fastener or adhesive. For example, the mounting surfaces, e.g., first and second flanges, of each of stiffeners 121, 121′ each can be coupled to the back of photovoltaic module 110 using any suitable combination of one or more adhesives. Illustratively, in a manner such as shown in FIG. 1B, small pieces of double-sided foam pad or tape 128, 128′ respectively can be used to adhere the upper right, upper left, lower right, and lower left corners of each of the first and second flanges of each of stiffeners 121, 121′ to the back of photovoltaic module 110, and a suitable adhesive, such as a silicone adhesive can be used to adhere stiffeners 121, 121′ along the length of each of the first and second flanges to the back of photovoltaic module 110. Optionally, foam pad(s) 128 can provide a first space between first stiffener 121 and photovoltaic module 110, and foam pad(s) 128′ can provide a second space between second stiffener 121′ and photovoltaic module 110. The adhesive, e.g., silicone adhesive, can be disposed within the first space and the second space. Additionally, or alternatively, foam pad(s) 128, 128′ can hold stiffeners 121, 121′ in place while the adhesive cures. Alternatively, any other suitable adhesive, such as elongated pieces of double-sided foam tape, can be used to adhere stiffeners 121, 121′ along the length of each of the first and second flanges to the back of photovoltaic module 110. In one non-limiting example, mounting system 120 is attached to the back-sheet or back glass of the photovoltaic module using a double sided foam tape. The tape adheres to the stiffener (hat channel) flanges and to the back of the photovoltaic module. In another non-limiting example, mounting system 120 is attached to the back of the module with silicone adhesive.

Mounting system 120 illustrated in FIGS. 1A-1D further can include first, second, third, and fourth legs 122, 123, 122′, and 123′. Each of first, second, third, and fourth legs 122, 123, 122′, and 123′ can have any suitable shape for supporting photovoltaic module 110 in an open position. Illustratively, in a manner such as illustrated in FIG. 1B, each of first, second, third, and fourth legs 122, 123, 122′, and 123′ can include an elongated structural member including a respective foot 125, 125, 125′, 126′ that is suitably configured so as to stably support the leg upon a surface with which the foot is contacted. First, second, third, and fourth legs 122, 123, 122′, and 123′ each can include any suitable material or combination of materials, such as any suitable combination of aluminum, polymer, or steel, e.g., stamped or roll-formed steel. In one non-limiting example, first, second, third, and fourth legs 122, 123, 122′, and 123′ each can include an electrically conductive material, such as a metal.

Mounting system 120 illustrated in FIGS. 1A-1D further can include first joint 140 rotatably coupling first leg 122 to first stiffener 121; second joint 141 rotatably coupling second leg 123 to first stiffener 121; third joint 140′ rotatably coupling third leg 122′ to second stiffener 121′; and fourth joint 141′ rotatably coupling fourth leg 123′ to second stiffener 121′. Optionally, first joint 140, second joint 141, third joint 140′, and fourth joint 141′ can have the same construction as one another. Illustratively, first joint 140, second joint 141, third joint 140′, and fourth joint 141′ each can include a structural member that is coupled both to the respective structural member and to the respective leg and configured so as to permit rotation of that leg relative to that stiffener. The structural member can include any suitable material or combination of materials, such as any suitable combination of aluminum, polymer, or steel, e.g., stamped or roll-formed steel. In one non-limiting example, the structural members of first, second, third, and fourth legs joints 140, 141, 140, and 141′ each can include an electrically conductive material, such as a metal.

In the non-limiting embodiment illustrated in FIGS. 1A-1D, mounting system 120 further includes first crossbrace 124 fixedly coupling first and second legs 122, 123 to one another; and second crossbrace 124′ fixedly coupling third and fourth legs 122′, 123′ to one another. Each of first crossbrace 124 and second crossbrace 124′ can have any suitable shape for respectively maintaining the position of first leg 122 relative to second leg 123 or the position of third leg 122′ relative to fourth leg 123′. Illustratively, in a manner such as illustrated in FIG. 1B, each of first and second crossbraces 124, 124′ can include a substantially flat structural member that is suitably coupled to the respective legs, e.g., using one or more fasteners 127 such as screws, bolts, adhesive, or the like, and is sufficiently stiff so as to inhibit rotation of the legs coupled thereto relative to one another, while permitting rotation of those legs as a unit relative to the stiffener to which those legs are attached. First and second crossbraces 124, 124′ each can include any suitable material or combination of materials, such as any suitable combination of aluminum, polymer, or steel, e.g., stamped or roll-formed steel. In one non-limiting example, first and second crossbraces 124, 124′ each can include an electrically conductive material, such as a metal.

In exemplary system 100 illustrated in FIGS. 1A-1D, first and second legs 122, 123 respectively are rotatable about first and second joints 140, 141 from a stowed position (such as illustrated in FIGS. 1B and 1C) to an open position supporting the photovoltaic module (such as illustrated in FIGS. 1A and 1D). Additionally, third and fourth legs 122′, 123′ respectively are rotatable about third and fourth joints 140′, 141′ from a stowed position (such as illustrated in FIGS. 1B and 1C) to an open position supporting the photovoltaic module (such as illustrated in FIGS. 1A and 1D). Optionally, when the first, second, third, and fourth legs 122, 123, 122′, 123′ respectively are in the stowed positions the first, second, third, and fourth legs each are folded flat against a back of the photovoltaic module and/or fit within the envelope of the optional photovoltaic frame 112, e.g., such as illustrated in FIG. 1C. Additionally, or alternatively, in embodiments in which photovoltaic module 110 includes frame 112, the first, second, third, and fourth legs 122, 123, 122′, 123′ fit within frame 112 when such legs are in the stowed position. As such, a plurality of photovoltaic modules 110 having mounting system 120 coupled thereto (with the legs in the stowed position) can be stacked on one another for compact transport to an installation site. At the installation site, the legs can be rotated to the open position for use in supporting the photovoltaic module at the installation site, e.g., upon a concrete ballast such as illustrated in FIG. 1A and described in greater detail herein.

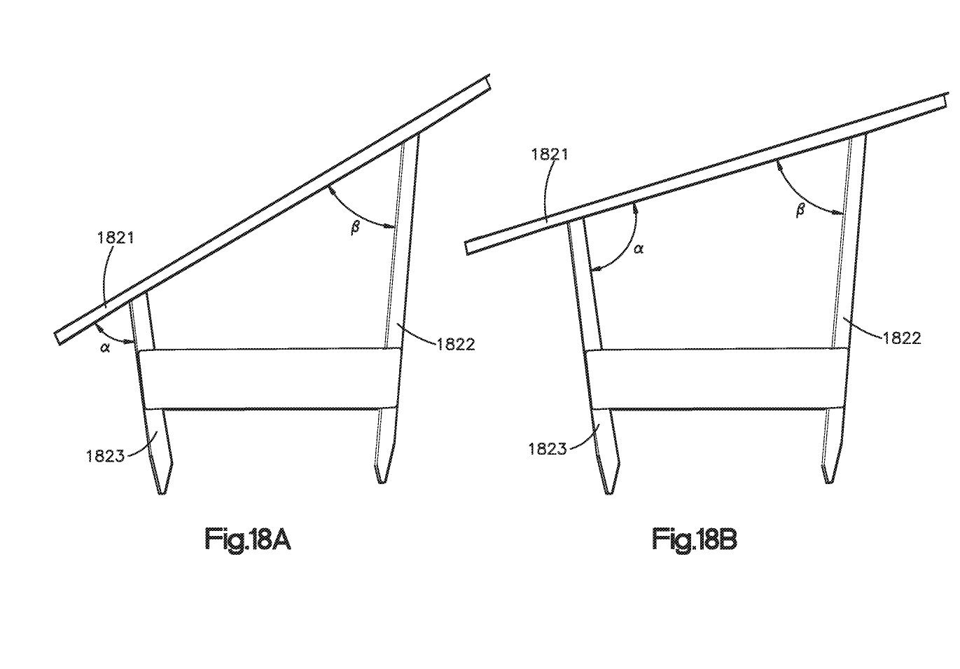

Additionally, or alternatively, when the first and second legs 122, 123 respectively are in the stowed position or in the open position, one or both of the first and second legs optionally can extend at an angle of between about 50 degrees and about 90 degrees from first stiffener 121, and/or when third and fourth legs 122′, 123′ respectively are in the stowed position or in the open position, the third and fourth legs each extend at an angle of between about 50 degrees and about 90 degrees from second stiffener 121′. For example, FIGS. 18A-18B illustrate exemplary embodiments in which photovoltaic modules have a preselected acute angle relative to the ground, e.g., an angle of between about 0° and about 60°, e.g., between about 5° and about 45°, e.g., between about 10° and about 35°. In the nonlimiting example shown in FIG. 18A, photovoltaic module 1821 can have an angle of about 33° relative to the ground. First leg 1822 can extend at an acute angle β of about 55° relative to stiffener 1821 (in both the stowed and open positions) and second leg 1823 can extend at an acute angle α of about 63° relative to stiffener 1821 (in both the stowed and open positions). In the nonlimiting example shown in FIG. 18B, photovoltaic module 1821 can have an angle of about 5° relative to the ground. First leg 1822 can extend at an acute angle β of about 74° relative to stiffener 1821 (in both the stowed and open positions) and second leg 1823 can extend at an acute angle α of about 72° relative to stiffener 1821 (in both the stowed and open positions). It should be appreciated that any suitable angles between legs and the corresponding stiffener can be selected, e.g., based on a desired angle of the photovoltaic module relative to the ground.

As noted further above and as illustrated in FIG. 1B, each of the first, second, third, and fourth legs 122, 123, 122′, 123′ optionally can include a respective foot 125, 126, 125′, 126′. In a manner such as illustrated in FIG. 1A, system 100 optionally can include concrete ballast 130 Concrete ballast 130 optionally can include first and second elongated grooves 131, 132 extending parallel to one another and parallel to concrete ballast 130. Feet 125, 125′ of first and third legs 122, 122′ respectively are insertable into first elongated groove 131, and/or feet 126, 126′ of second and fourth legs 123, 123′ respectively are insertable into second elongated groove 132, e.g., when the first, second, third, and fourth legs 122, 123, 122′, 123′ respectively are in the open position. Optionally, the respective foot 125, 126, 125′, 126′ of each of the first, second, third, and fourth legs 122, 123, 122′, 123′ includes a tapered portion of the respective leg, e.g., such as illustrated in FIG. 1B. Grooves 131, 132 can be configured so as to slidably receive and engage such tapered feet in such a manner as to inhibit movement of the feet in a direction that is laterally perpendicular to the direction in which grooves 131, 132 extend, while permitting movement of the feet in a direction that is laterally parallel to the direction in which grooves 131, 132 extend.

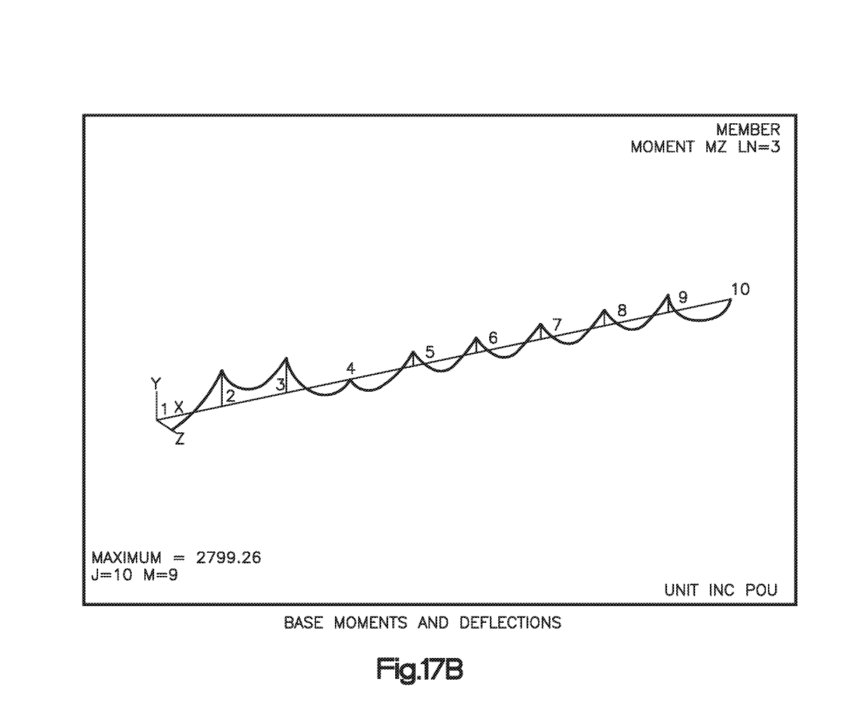

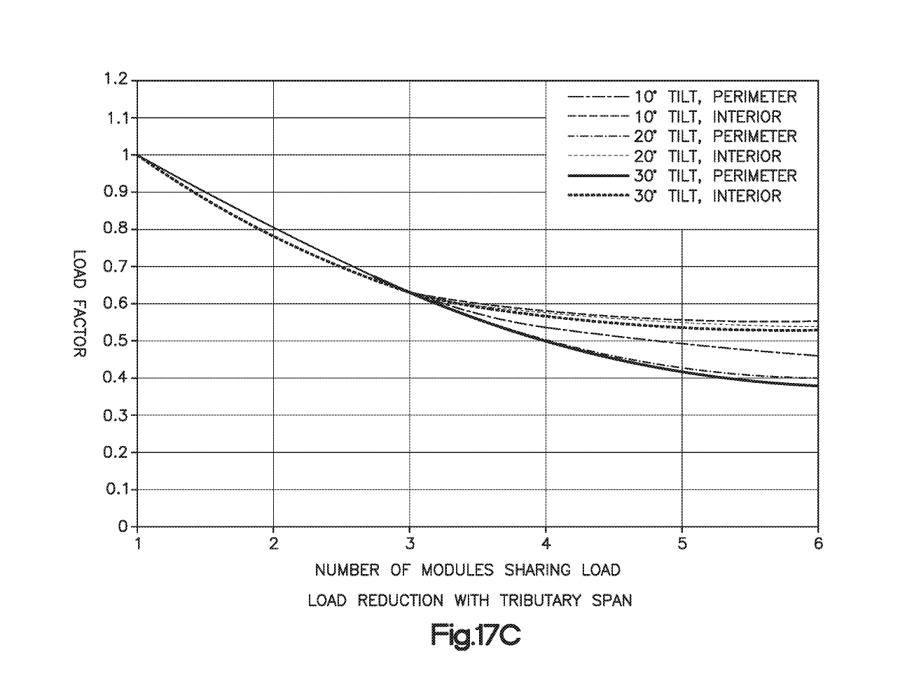

Concrete ballast 130 illustrated in FIG. 1A optionally can include one or more additional features that can facilitate installation, maintenance, and/or stability of photovoltaic module 110 and mounting system 120. For example, in the non-limiting embodiment illustrated in FIG. 1A, concrete ballast 130 can include first and second raised surfaces 133, 135 having first groove 131 disposed therebetween, and/or third and fourth raised surfaces 134, 136 having second groove 132 disposed therebetween. First, second, third, and fourth raised surfaces 133, 134, 135, 136 can be of sufficient height as respectively to provide grooves 131, 132 with sufficient depth as to securely engage feet 125, 126, 125′, 126′ of each of the first, second, third, and fourth legs 122, 123, 122′, 123′. Optionally, concrete ballast 130 can include a reduced height surface 137, e.g., disposed between raised surfaces 134, 135, which reduced height surface optionally can serve as a plenum for cabling. Additionally, or alternatively, concrete ballast 130 can include first and second vehicle support surfaces 138, 139 that respectively can receive and support wheels, treads, or tracks of an installation vehicle or an operation and maintenance vehicle. Additionally, or alternatively, concrete ballast 130 further can include one or more interlocking control joints, e.g., such as described in greater detail herein with reference to FIG. 17A. Additionally, or alternatively, a plurality of photovoltaic modules 110 can be mounted along concrete ballast 130, e.g., such as described in greater detail herein with reference to FIGS. 17B-17C.

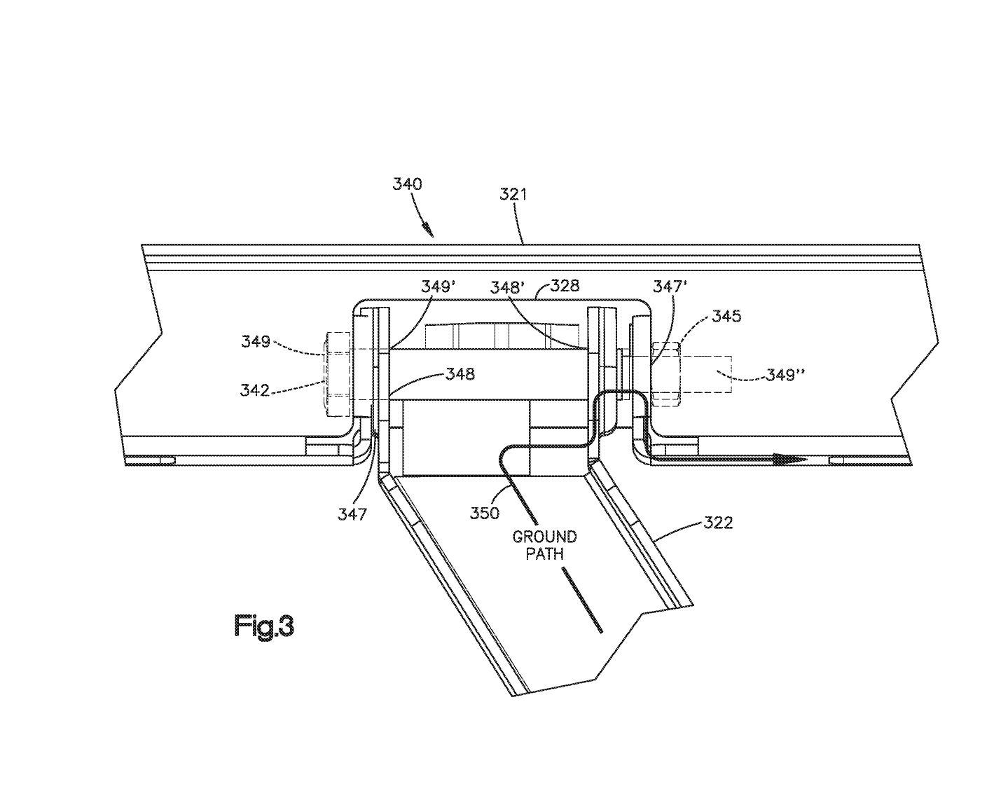

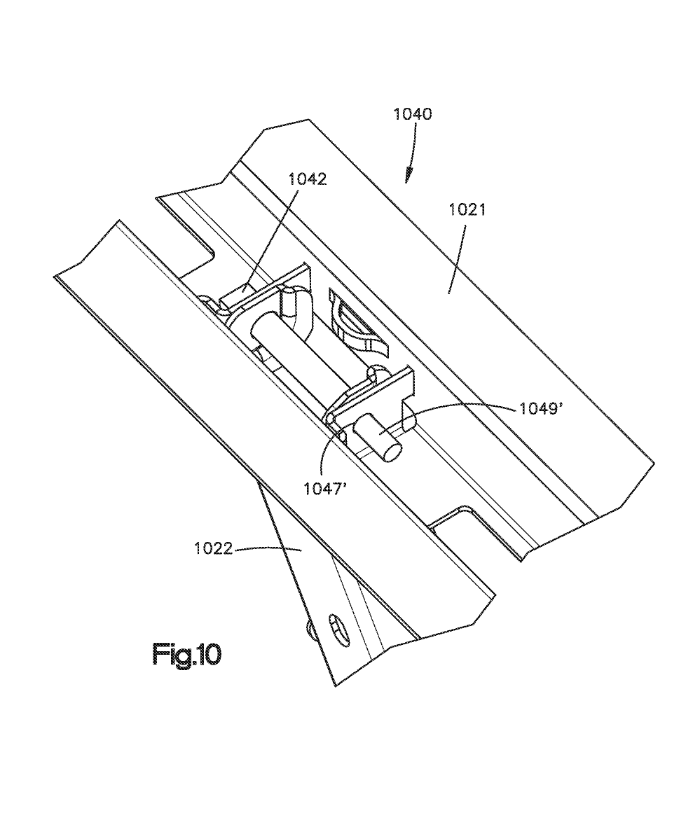

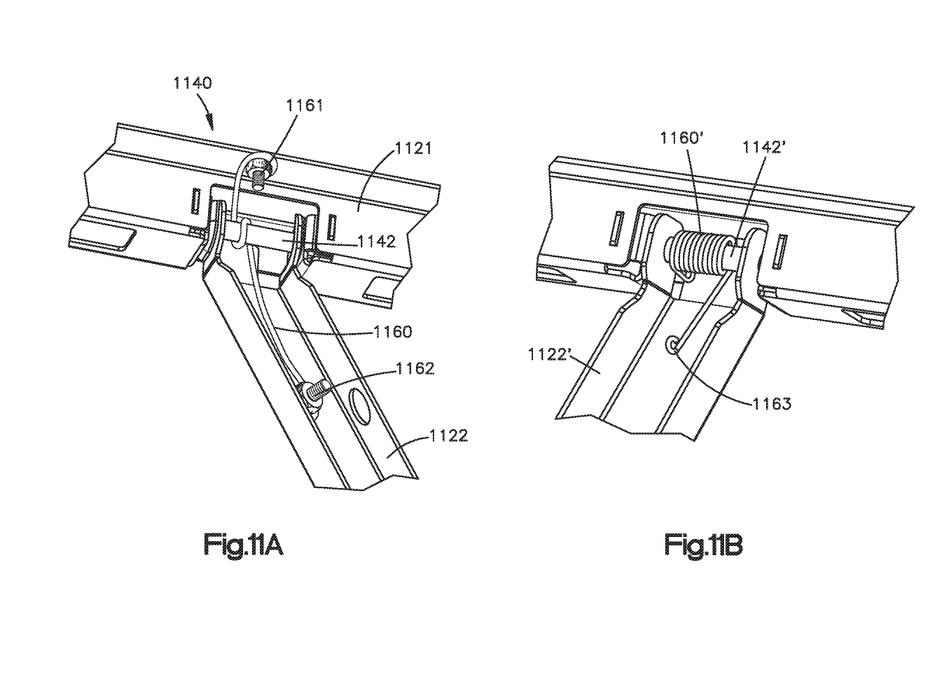

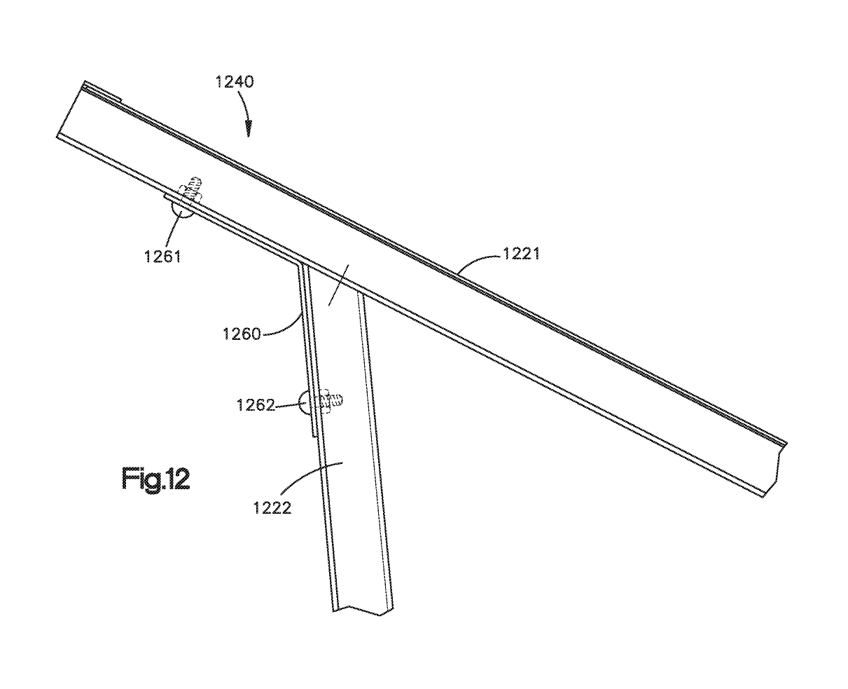

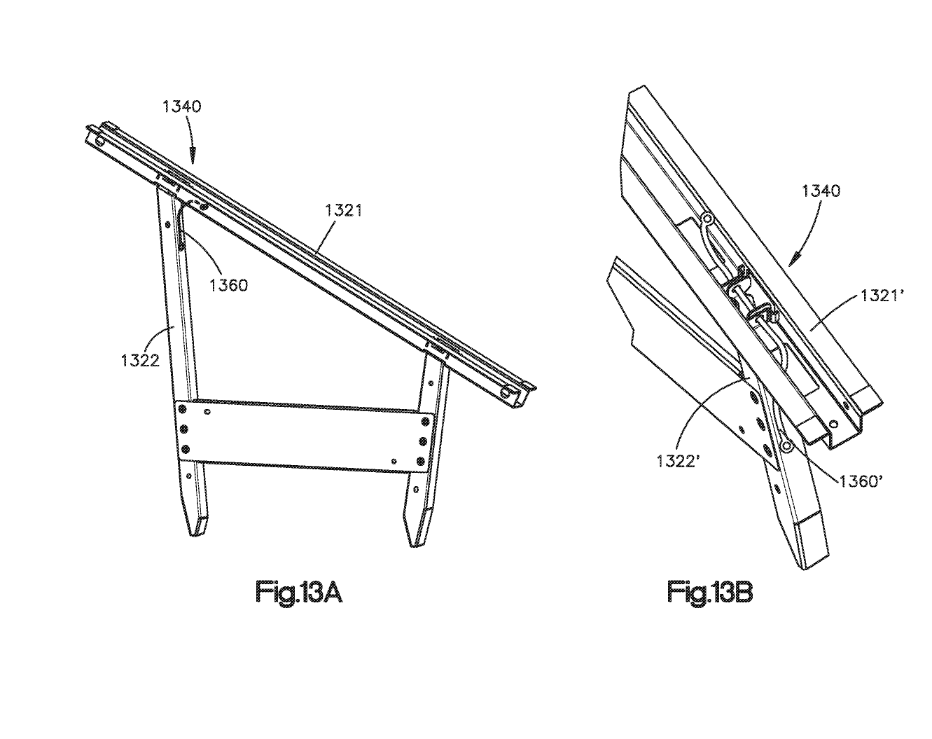

It should be appreciated that first and second joints 140, 141 can include any suitable structure configured to permit rotation of the respective leg relative to the respective stiffener. For example, in a manner similar to that illustrated in FIG. 1D for first joint 140, each of the first, second, third, and fourth joints 140, 141, 140′, 141′ can include a respective hinge pin (e.g., hinge pin 142) extending through first and second apertures defined through the respective stiffener (e.g., stiffener 121) and extending through third and fourth apertures defined through the respective leg (e.g., leg 122). Optionally, in a manner such as described in greater detail herein with reference to FIGS. 2-15, one or more of the each of the first, second, third, and fourth joints 140, 141, 140′, 141′ optionally further can include an electrical conductor disposed between and coupled to each of the respective stiffener and the respective leg. For example, at least one of joints 140, 141 can include such an electrical conductor, and at least one of joints 140, 141′ can include such an electrical conductor. Optionally, the electrical conductor can be routed around the hinge pin in a manner such as described herein with reference to FIGS. 11A-11B, and additionally or alternatively optionally can include a spring that forces the respective leg into the open position, e.g., such as described herein with reference to FIGS. 11A-11B and 13C. As a another option, the electrical conductor can include a sheet metal strap, e.g., such as described herein with reference to FIG. 12. As another option, the electrical conductor can include a wire, e.g., such as described herein with reference to FIGS. 13A-13B, and/or optionally the hinge pin can include a portion of the wire, e.g., such as described herein with reference to FIG. 13B, and/or the wire can provide a spring that forces the respective leg open, e.g., such as described herein with reference to FIG. 13C. As another option, each hinge pin can include a shoulder bolt including a shoulder having a first diameter and a threaded portion having a second diameter that is smaller than the first diameter, and each joint can include a nut threaded on the threaded portion of the respective hinge pin, the nut and shoulder clamping the respective leg against the respective stiffener so as to provide an electrical connection between that leg and that stiffener, e.g., such as described herein with reference to FIGS. 3, 4A-4B, 5A-5B, or 6-9.

Referring again to FIG. 1D, one or more of the first, second, third, or fourth joints 140, 141, 140′, 141′ optionally can include one or more structural members configured to inhibit rotation of the respective leg 122, 123, 122′, 123′ beyond a desired angle. For example, joint 140 can include bridge lance feature 143 configured to engage with the end of leg 122 so as to stop rotation of leg 122 at a particular angle relative to stiffener 121 as to suitably support photovoltaic module 110. Optionally, bridge lance feature 143 can be provided as part of stiffener 121, e.g., can be a feature in the material of stiffener 121, e.g., can be a feature in sheet metal. Additionally, or alternatively, in a manner such as illustrated in FIG. 1D, first and second stiffeners 121, 121′ optionally can include one or more tool access holes 144, e.g., for a wrench or other suitable tool to access the respective joint (e.g., so as to access hinge pin 142 of joint 140 illustrated in FIG. 1D). Illustratively, tool access holes such as hole 144 illustrated in FIG. 1D can be used to remove hinge pin 142, e.g., by removing a nut threaded onto hinge pin 142 and removing hinge pin 142, so as to decouple stiffener 121 from an installed leg 122 and thus facilitate removal of photovoltaic module 110 from the installed legs, such as for servicing module 110 while leaving the legs in place. The module 110 then can be replaced by re-coupling stiffener 121 and installed leg 122, e.g., by replacing hinge pin 142 and re-threading the nut. As yet another option, which can be used alone or in combination with any of the other options, system 100 further can include an electrical conductor disposed between and coupled to the photovoltaic module and the first stiffener, the electrical conductor optionally being configured to support cables underneath the photovoltaic module, e.g., such as described in greater detail herein with reference to FIGS. 16A-16E.

It can be useful for components of a photovoltaic module mounting system to be electrically bonded with one another and/or bonded to ground, e.g., so as to reduce the likelihood of charge buildup that otherwise can cause electrical shock that can be injurious to workers or to electronic components. In some embodiments, the present systems and methods provide joints between stiffeners and legs for supporting a photovoltaic module, that include certain electrical and/or mechanical couplings between the stiffeners and the legs. For example, FIG. 2 schematically illustrates a side view of grounding paths within an exemplary system for mounting a photovoltaic module, according to some embodiments. In a manner similar to that described above with reference to FIGS. 1A-1D, system 200 illustrated in FIG. 2 includes photovoltaic module 210 including photovoltaic panel 211 and frame 212; a mounting system including stiffener 221 coupled to photovoltaic module 210; a leg, e.g., first and second legs 222, 223; and a joint rotatably coupling the at least one leg to the stiffener between a stowed position and an open position, e.g., first and second joints 240, 241. Additionally, system 200 illustrated in FIG. 2 includes an electrical member electrically bonding the stiffener and the leg to one another in at least the open position, e.g., includes first and second electrical members that respectively provide electrical pathways between stiffener 221 and legs 222, 223 via joints 240, 241. As such, joints 240, 241 provide rotating structural hinges that can be used for bonding, e.g., as ground path 250 (bold lines signify equipment ground path for system 200).

Such an electrical member can be provided using any suitable combination of structures and materials. For example, FIG. 3 schematically illustrates an exemplary joint for mechanically and/or electrically bonding a leg to a stiffener within an exemplary system for mounting a photovoltaic module, according to some embodiments. In the non-limiting embodiment illustrated in FIG. 3, joint 340 includes hinge pin 342 extending through first and second apertures 347, 347′ defined through stiffener 321 and extending through third and fourth apertures 348, 348′ defined through leg 322. Illustratively, hinge pin 342 can include a shoulder bolt that includes bolt head 349, shoulder 349′ having a first diameter, and threaded portion 349″ having a second diameter that is smaller than the first diameter. The electrical member of joint 340 can include nut 345, which can be threaded on threaded portion 349″ of hinge pin 342. Nut 345 can clamp respective leg 322 against stiffener 321 so as to provide an electrical connection between leg 322 and stiffener 321, e.g., so as to provide bonding between leg 322 and stiffener 321, which can, in one example, provide ground path 350. In some embodiments, the shoulder bolt for the high edge hinge and the nut clamp the high edge leg 322 to stiffener 321. Nut 345 can be sufficiently tightened so as to provide a predetermined amount of torque. For example, nut 345 can be sufficiently tightened as to provide an electrical pathway between leg 322 and stiffener 321 as to comply with the UL 2703 standard, e.g., can provide an electrical pathway having a resistance of about 0.1 Ohms or less. Optionally, threadlocker (e.g., LOCTITE® Threadlocker, commercially available from Henckel Corp., USA) can be applied on threads of the hinge pin where nut 345 is installed to prevent or inhibit joint 340 from loosening, e.g., so as to inhibit unlocking of nut 345 such as when leg 322 (other respective leg) is deployed from the stowed position inside the module frame, such as frame 112 illustrated in FIG. 1A or frame 212 illustrated in FIG. 2. Optionally, one or more washers (not specifically labeled) can be disposed between head 349 and first aperture 347 and/or between nut 345 and second aperture 347′.

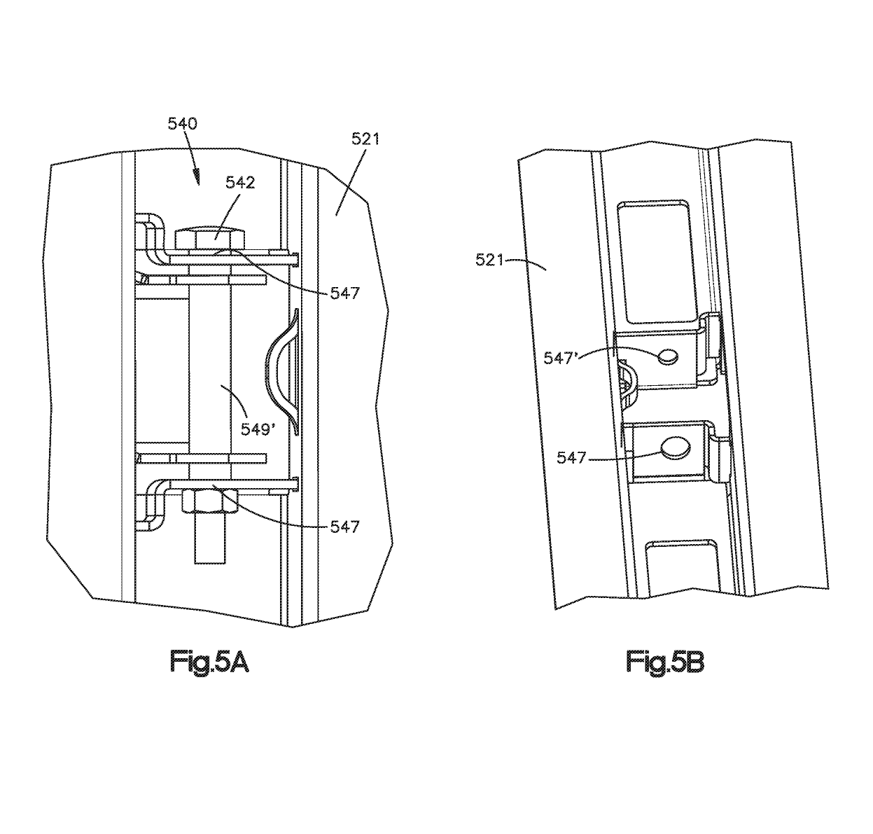

In some embodiments, hinge pin 342 and apertures 347, 347′, 348, 348′ are configured so as to permit free rotation of hinge pin 342 within such apertures when leg 322 is rotated from the closed position to the open position in a manner such as described herein with reference to FIGS. 1A-1D. In other embodiments, e.g., such as described herein with reference to FIGS. 5A-9, at least a portion of hinge pin 342 and at least one of first and second apertures 347, 347′ are shaped so as to interlock with one another so as to inhibit rotation of hinge pin 342 relative to stiffener 321. Another exemplary configuration for inhibiting rotation of hinge pin 342 relative to stiffener 321 is described herein with reference to FIG. 11. In one example, one side of the hinge (joint) is rotating freely, and one side of the hinge (joint) is clamped together providing electrical connection between leg 322 and stiffener 321.

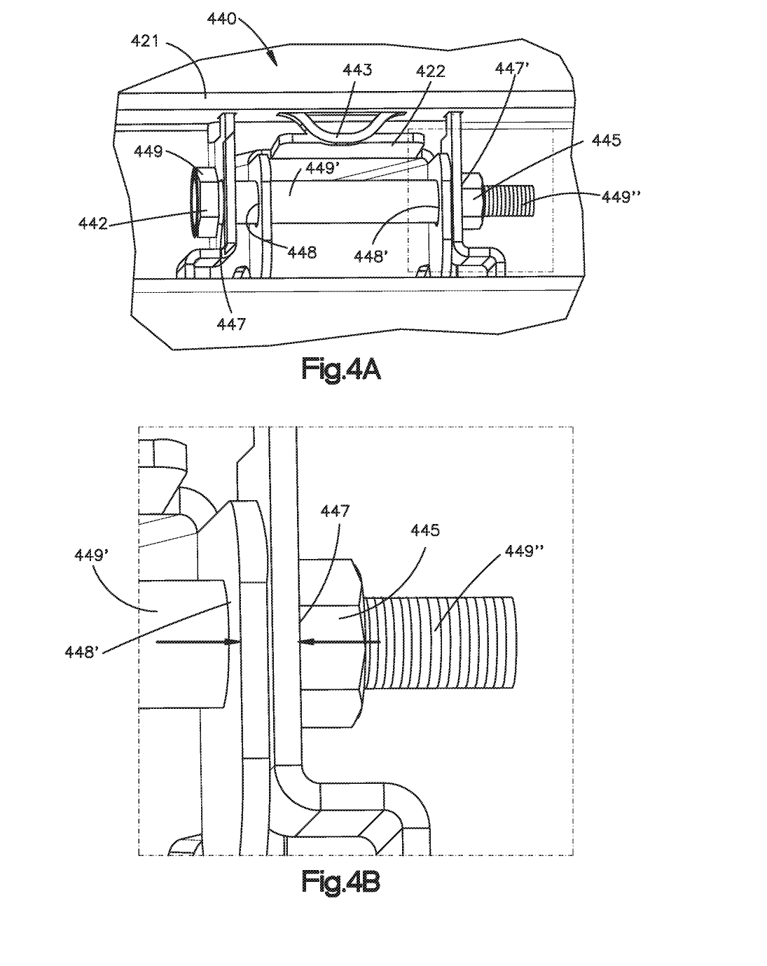

FIGS. 4A-4B schematically illustrate views of an exemplary joint for mechanically and/or electrically bonding a leg to a stiffener within an exemplary system for mounting a photovoltaic module, according to some embodiments. FIG. 4A illustrates a view from the top of the hinge (joint) 440, and FIG. 4B illustrates a close-up of the bond. In a manner similar to that described herein with reference to FIG. 3, joint 440 includes hinge pin 442 extending through first and second apertures 447, 447′ defined through stiffener 421 and extending through third and fourth apertures 448, 448′ defined through leg 422. Illustratively, hinge pin 442 can include a shoulder bolt that includes bolt head 449, shoulder 449′ having a first diameter, and threaded portion 449″ having a second diameter that is smaller than the first diameter. The electrical member of joint 440 can include nut 445, which can be threaded on threaded portion 449″ of hinge pin 442. Nut 445 and the shoulder 449′ can clamp respective leg 422 against stiffener 421 so as to provide an electrical connection between leg 422 and stiffener 421, e.g., so as to provide bonding between leg 422 and stiffener 421, which can, in one example, provide ground path 450. In some embodiments, the shoulder bolt for the high edge hinge clamps the high edge leg 422 to stiffener 421. Optionally, threadlocker (e.g., LOCTITE® Threadlocker, commercially available from Henckel Corp., USA) can be applied on threads where nut 445 is installed to prevent or inhibit joint 440 from loosening, e.g., when leg 422 (other respective leg) is deployed from the stowed position inside the module frame, such as frame 112 illustrated in FIG. 1A or frame 212 illustrated in FIG. 2. Optionally, one or more washers (not specifically labeled) can be disposed between head 449 and first aperture 447 and/or between nut 445 and second aperture 447′.

A summary of an exemplary installation procedure can include the following steps, which should not be construed as limiting: 1. Insert shoulder bolt into hinge (e.g., insert shoulder bolt 442 into first, second, third, and fourth apertures 447, 447′, 448, 448′ of joint 440). 2. Apply threadlocker onto the threads that will engage with the nut (e.g., apply LOCTITE® or other suitable threadlocker onto the threads of shoulder bolt portion 449″ that will engage with nut 445). Rotate the screw around to ensure that the LOCTITE® is distributed on the threading (e.g., rotate shoulder bolt 442 to ensure that the LOCTITE® or other suitable threadlocker is distributed on the threading in portion 449″). 3. Tighten the nut to the specified torque (e.g., tighten nut 445 to a sufficient torque to provide electrical bonding between leg 422 and stiffener 421). 4. Leave system in the closed position for 72 hours (e.g., maintain leg 422 in the stowed position, parallel to the photovoltaic module, for a sufficient amount of time for the threadlocker to harden). Optionally, joint 440 can include bridge lance 443 configured so as to inhibit rotation of leg 422 past the open position.

In some embodiments, at least a portion of hinge pin 442 and at least one of first and second apertures 447, 447′ are shaped so as to interlock with one another so as to inhibit rotation of hinge pin 442 relative to stiffener 421. For example, FIGS. 5A-5B schematically illustrate views of another exemplary joint for mechanically and/or electrically bonding a leg to a stiffener within an exemplary system for mounting a photovoltaic module, according to some embodiments. Joint 540 illustrated in FIGS. 5A-5B is configured similarly as is joint 440 illustrated in FIGS. 4A-4B, except that hinge pin (shoulder bolt) 542 includes a D-shaped profile in shoulder region 549′ (D-shape hinge body), and first aperture 547 of stiffener 521 is D-shaped (stiffener D-shape profile) so as to engage with shoulder region 549′ in such a manner as to inhibit rotation of hinge pin 542 relative to stiffener 521. A nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

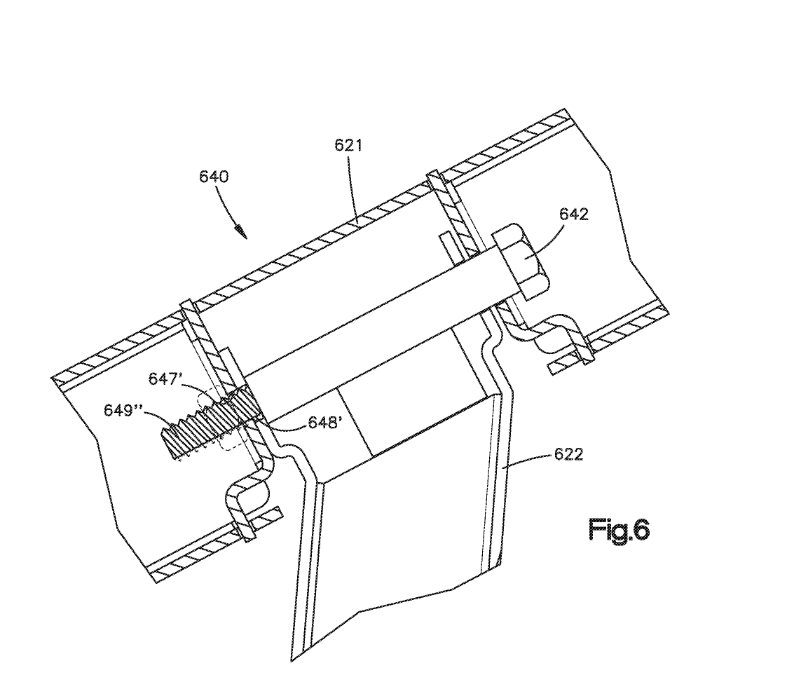

Other suitable shapes of the hinge pin and/or apertures of the stiffener, as well as other arrangements of elements, suitably can be selected for optionally inhibiting rotation of the hinge pin relative to the stiffener. For example, FIGS. 6-15 schematically illustrate additional exemplary joints for mechanically and/or electrically bonding a leg to a stiffener within an exemplary system for mounting a photovoltaic module, according to some embodiments. FIG. 6 schematically illustrates a plan view of an exemplary joint 640 configured similarly as is joint 440 illustrated in FIGS. 4A-4B, except that the threaded portion 649″ of hinge pin (shoulder bolt) 642 is flattened on the threads, and second aperture 647′ of stiffener 621 includes a flat portion that engages with the flat portion of hinge pin 642 in such a manner as to inhibit rotation of hinge pin 642 relative to stiffener 621. In some embodiments, the flat portion of threaded portion 649″ does not engage with leg 622, e.g., does not engage with fourth aperture 648′ of leg 622. A nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

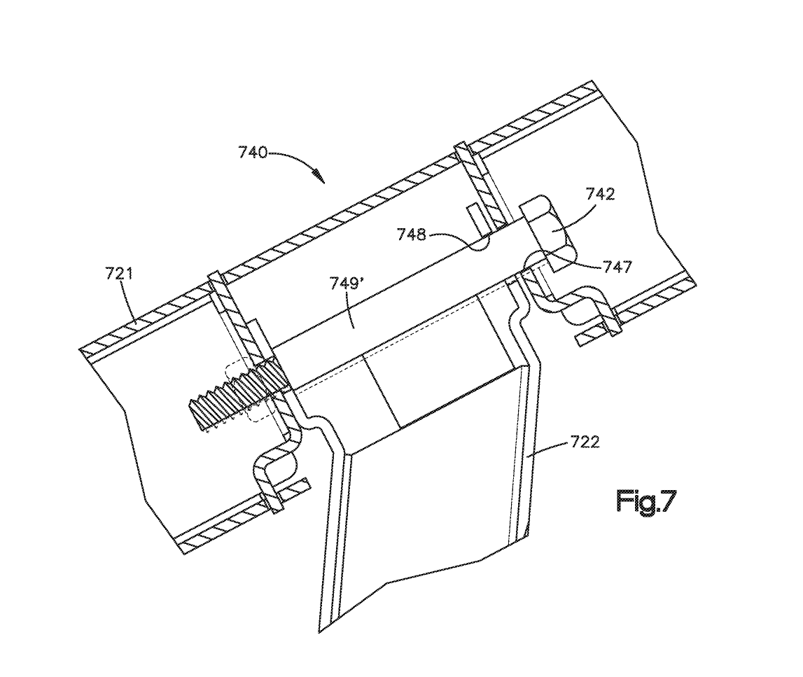

FIG. 7 schematically illustrates a plan view of another exemplary joint 740 configured similarly as is joint 440 illustrated in FIGS. 4A-4B, except that the shoulder portion 749′ of hinge pin (shoulder bolt) 742 is flattened on one side, and first aperture 747 of stiffener 721 includes a flat portion that engages with the flat portion of hinge pin 742 in such a manner as to inhibit rotation of hinge pin 742 relative to stiffener 721. In some embodiments, the flat portion of shoulder portion 749′ does not engage with leg 722, e.g., does not engage with third aperture 748 of leg 722. A nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

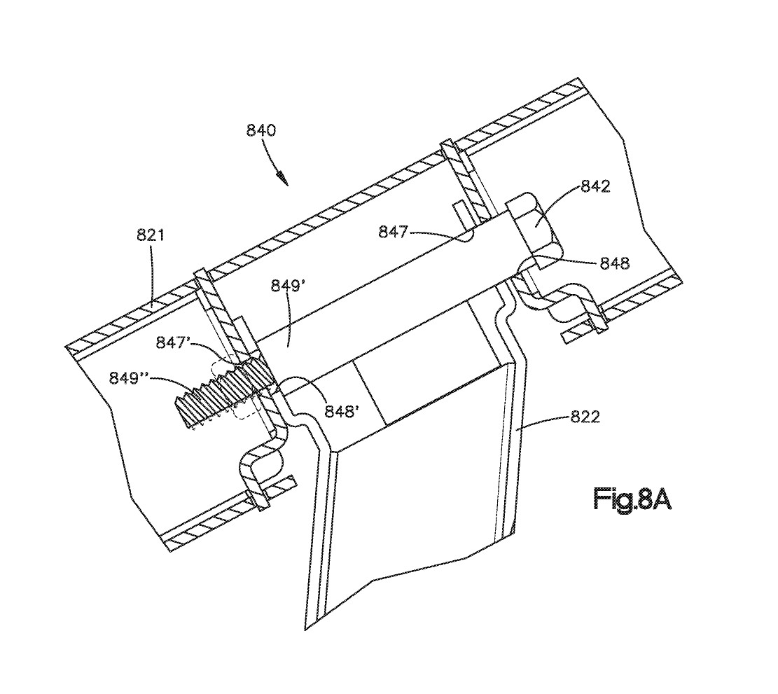

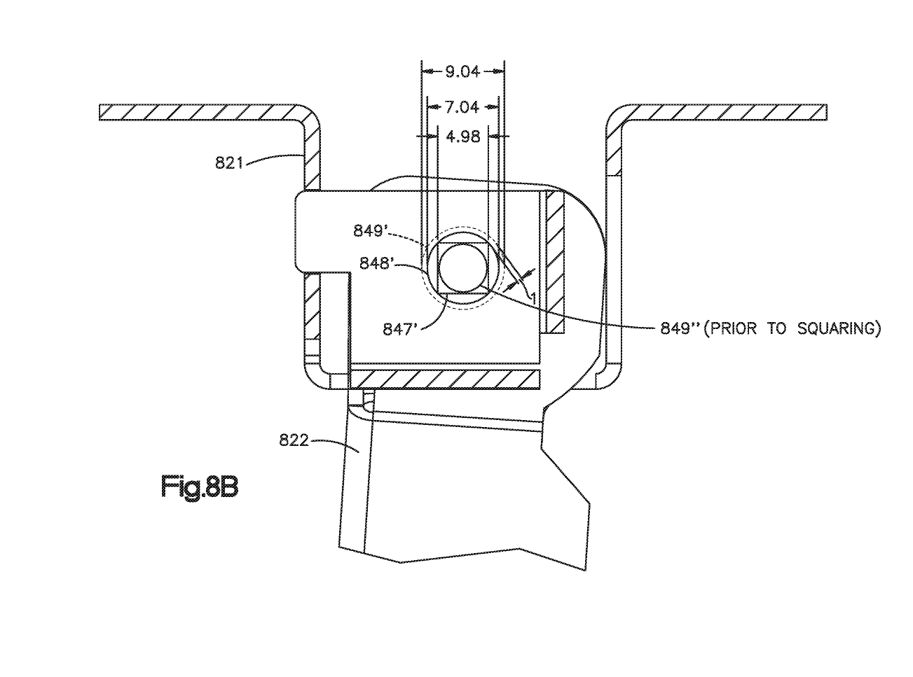

FIGS. 8A-8B schematically illustrate plan and cross-sectional views of an exemplary joint 840 configured similarly as is joint 440 illustrated in FIGS. 4A-4B, except that the bottom portion of shoulder portion 849′ of hinge pin (shoulder bolt) 842 is squared, and second aperture 847′ of stiffener 821 includes or is a square hole that engages with the squared section of hinge pin 842 in such a manner as to inhibit rotation of hinge pin 842 relative to stiffener 821. In some embodiments, the squared portion of shoulder portion 849′ does not engage with leg 822, e.g., does not engage with fourth aperture 848′ of leg 822. In one nonlimiting example, leg 822 can have a round hole (e.g., fourth aperture 848′), and the diameter is increased to allow for the squared cross section to rotate; the shoulder diameter (e.g., diameter of shoulder portion 849′) is increased so as to maintain the clamping area; and the holes in the stiffener and the leg is increased because the shoulder increased (e.g., first and third apertures 847, 848 respectively in stiffener 821 and leg 822 can be increased so as to accommodate and allow rotation of the increased diameter shoulder portion 849′). FIG. 8B illustrates some non-limiting examples of dimensions and shapes for the second and fourth apertures 847′, 848′ and for shoulder portion 849′ and threaded portion 849″ (prior to squaring). Other shapes and dimensions suitably can be used. A nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

Indeed, although FIGS. 5A-8B illustrate non-limiting embodiments in which a certain portion of the hinge pin and/or an aperture through the stiffener include exemplary shapes that engage with one another in such a manner as to inhibit rotation of the hinge pin relative to the stiffener, it should be appreciated that any suitable portion(s) of the hinge pin and/or of the stiffener can have any suitable interlocking shape so as to inhibit rotation of the hinge pin. In mechanical hinge bonding, an exemplary rotation locking feature can include one or more of the following features:

Shoulder bolt head or body has non-circular profile created,

Stiffener gets non-circular female profile, and/or

Shoulder bolt profiles lock with female profile on stiffener.

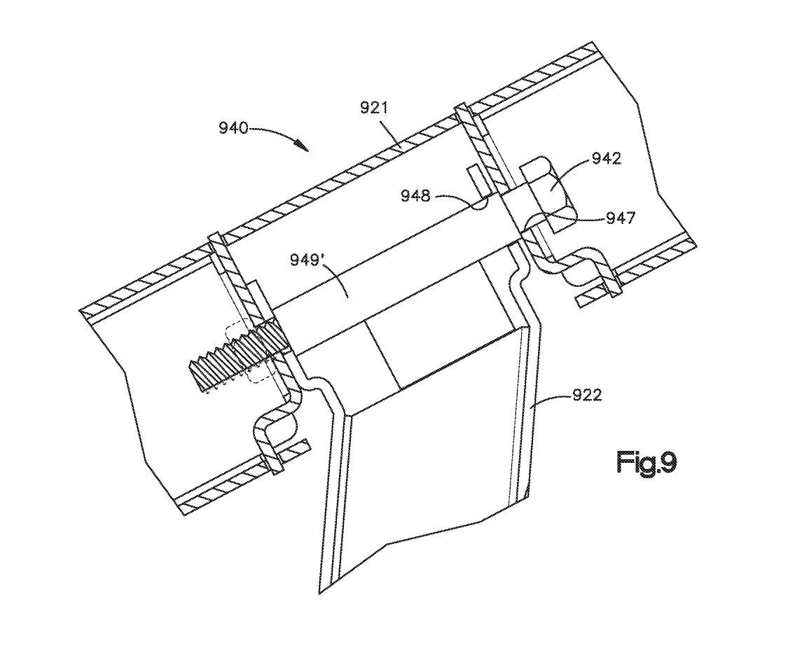

The non-circular shape locks either the threads, shoulder, and head of the shoulder bolt fastener. For example, FIG. 9 illustrates a plan view of another exemplary joint 440 configured similarly as is joint 940 illustrated in FIGS. 4A-4B, except that the upper portion of shoulder portion 949′ of hinge pin (shoulder bolt) 942 is squared, and first aperture 947 of stiffener 921 also is square so as to engage with the squared portion of hinge pin 942 in such a manner as to inhibit rotation of hinge pin 942 relative to stiffener 921. In some embodiments, shoulder portion 949′ is shaped so that the squared portion does not engage with leg 922, e.g., does not engage with third aperture 948 of leg 922. The shoulder bolt can clamp the leg to the stiffener, and a nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

It also should be appreciated that the present joints can include any suitable mechanism in addition to, or other than, a non-circularly shaped hinge pin and/or stiffener aperture so as to inhibit rotation of the hinge pin relative to the stiffener. For example, in interference fit can be created to lock the fastener (hinge pin) in with material and/or a non-circular shape (or circular with serrations) can be used to lock the fastener in place.

Illustratively, the hinge pin and at least one of the first and second apertures can be interference fit or welded with one another so as to inhibit rotation of the hinge pin relative to the stiffener. For example, FIG. 10 schematically illustrates a perspective view of another exemplary joint 1040 configured similarly as is joint 440 illustrated in FIGS. 4A-4B, except that threaded portion 1049″ of hinge pin (shoulder bolt) 1042 is interference fit with second aperture 1047′ of stiffener 1021 so as to engage with the second aperture in such a manner as to inhibit rotation of hinge pin 1042 relative to stiffener 1021. The shoulder bolt can clamp the leg to the stiffener, and a nut can be placed on the end of the shoulder bolt threads in a manner similar to that described herein with reference to FIGS. 3 and 4A-4B. Note that the interference fit can be at any suitable location of the hinge pin and/or the stiffener. For example, in embodiments that include shoulder bolt interference with the stiffener, the interference can be with the shoulder bolt head, body, threads, or any suitable combination thereof, e.g., the joint can also have interference fit with the threads. Alternatively, hinge pin 1042 and at least one of the first and second apertures can be welded to one another so as to inhibit rotation of the hinge pin relative to the stiffener. For example, some embodiments weld part of the fastener (hinge pin 1042) to the stiffener 1021 (e.g., either the threads to or of the stiffener, shoulder body to the stiffener, or the shoulder head to the stiffener). The fastener (hinge pin) can be locked in place relative to the stiffener, allowing the leg 1022 to rotate. A nut can be placed on the end of the shoulder bolt threads in a manner similar to that described herein with reference to FIGS. 3 and 4A-4B. The nut can be considered to be an electrical member electrically bonding the stiffener and the leg to one another in at least the open position, but the nut needs not necessarily be a part of the electrical pathway between the stiffener and the leg.

It further should be appreciated that the present joints can include any suitable configuration for electrically bonding a leg to a stiffener. For example, the electrical member can include an electrical conductor disposed between and coupled to each of the stiffener and the leg. The electrical conductor can be routed around the hinge pin and/or can include a spring that forces the leg into the open position. For example, FIG. 11A schematically illustrates a view of an exemplary joint 1140 rotatably coupling leg 1122 to stiffener 1121 between a stowed position and an open position in a manner similar to that described herein with reference to FIGS. 1A-1D. Electrical member 1160 electrically bonds the stiffener and the leg to one another in at least the open position, and is routed one or more times around the hinge pin and includes a spring that forces the leg into the open position. The electrical member (electrical conductor) 1160 between leg 1122 and stiffener 1121 can include, or be made of, aluminum, copper, stainless steel, or other flexible conductor. The conductor can be routed around hinge pin 1142. In the embodiment illustrated in FIG. 11A, hinge pin 1142 is bonded to stiffener 1121 in a manner such as described herein with reference to FIGS. 3-10. An electrical conductive connection 1162 of conductor 1160 to leg piece 1122 can be provided using a bolt, rivet, clinch fastener, spot weld, or other mechanical means. Additionally, an electrical conductive connection 1161 of conductor 1160 to stiffener 1121 can be provided using a bolt, rivet, clinch fastener, spot weld, or other mechanical means. The electrical conductor can be routed any suitable number of times around the hinge pin. For example, FIG. 11B schematically illustrates an embodiment in which electrical conductor 1160′ includes a spring routed multiple times around hinge pin 1142′. The spring in the hinge (joint) forces the leg(s) 1122′ into the open position. Element 1163 can provide a connection to leg 1122′ in a manner similar to that illustrated in FIG. 11A. An electrical conductive connection of conductor 1160′ to leg piece 1122′ can be provided using a bolt, rivet, clinch fastener, spot weld, or other mechanical means (not specifically illustrated, but can be similar as shown in FIG. 11A). Additionally, an electrical conductive connection 1161′ of conductor 1160′ to stiffener 1121′ can be provided using a bolt, rivet, clinch fastener, spot weld, or other mechanical means (not specifically illustrated, but can be similar as shown in FIG. 11A).

In other embodiments, the electrical conductor need not necessarily be routed around the hinge pin. For example, FIG. 12 schematically illustrates a cross-sectional view of an exemplary joint 1240 rotatably coupling leg 1222 to stiffener 1221 between a stowed position and an open position in a manner similar to that described herein with reference to FIGS. 1A-1D. Electrical member 1260 electrically bonds the stiffener and the leg to one another in at least the open position, and electrical conductor 1260 includes a sheet metal strap (separate bend sheet metal plate). The electrical member (electrical conductor) 1260 between leg 1222 and stiffener 1221 can include, or be made of, aluminum, copper, steel, stainless steel, or other flexible conductor. An electrical conductive connection 1262 of conductor 1260 to leg piece 1222 can be provided using a PEM fastener, bolt, rivet, clinch fastener, spot weld, or other mechanical means. For example, the metal bonding strap (electrical conductor) can be bolted between the leg and the stiffener piece. Additionally, an electrical conductive connection 1261 of conductor 1260 to stiffener 1221 can be provided using a PEM fastener, bolt, rivet, clinch fastener, spot weld, or other mechanical means. The fasteners for the metal strap can be installed in the factory or in the field. For example, leg 1222 can be rotated to the open position before providing one or both of electrical conductive connections 1261 and 1262. Optionally, after leg 1222 is rotated to the open position and after electrical conductive connections 1261 and 1262 are provided, electrical conductor 1260 can maintain leg 1222 in the open position for any desired period of time, e.g., for the service life of the photovoltaic module to which stiffener 1221 is attached.

In still other embodiments, the electrical conductor can include a wire. For example, FIG. 13A schematically illustrates a perspective view of an exemplary joint 1340 in which the electrical conductor includes a flexible wire 1360 connecting stiffener 1321 to leg 1322. An electrical conductive connection of conductor 1360 to leg piece 1322 can be provided using a bolt, rivet, clinch fastener, spot weld, or other mechanical means. Additionally, an electrical conductive connection of conductor 1360 to stiffener 1321 can be provided using a bolt, rivet, clinch fastener, spot weld, or other mechanical means. In some embodiments, the flexible wire connecting the stiffener to the leg makes electrical connection in both open and closed positions of the leg. Optionally, the hinge pin can include a portion of the wire. Put another way, the wire can be used as a hinge pin. For example, FIG. 13B schematically illustrates a perspective view of an exemplary joint 1340′ in which the electrical conductor includes a flexible wire 1360′ connecting stiffener 1321′ to leg 1322′, wherein wire 1360′ passes through first and second apertures through stiffener 1321′ and through third and fourth apertures through leg 1322′ in a manner similar to that of the hinge pin described above with reference to FIGS. 3 and 4A-4B. An electrical conductive connection of conductor 1360′ to leg piece 1322′ can be provided using a bolt, rivet, clinch fastener, spot weld, or other mechanical means. Additionally, an electrical conductive connection of conductor 1360′ to stiffener 1321′ can be provided using a bolt, rivet, clinch fastener, spot weld, or other mechanical means. As another example, FIG. 13C schematically illustrates a perspective view of an exemplary joint 1340″ in which the electrical conductor includes wire 1360″ connecting stiffener 1321″ to leg 1322″, wherein wire 1360″ passes through first and second apertures through stiffener 1321″ and through third and fourth apertures through leg 1322″ in a manner similar to that of the hinge pin described above with reference to FIGS. 3 and 4A-4B or wire 1360′ described above with reference to FIG. 13B. Optionally, wire 1360″ illustrated in FIG. 13C can have sufficient stiffness to force leg 1322″ into the open position. An electrical conductive connection of conductor 1360″ to leg piece 1322″ can be provided using a bolt, rivet, clinch fastener, spot weld, or other mechanical means. Additionally, an electrical conductive connection of conductor 1360″ to stiffener 1321″ can be provided using a bolt, rivet, clinch fastener, spot weld, or other mechanical means.

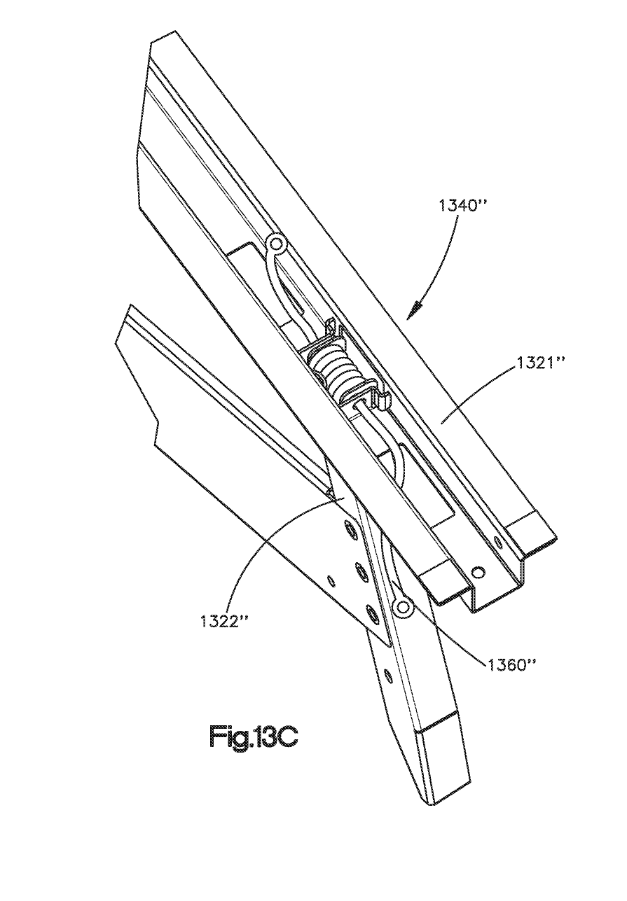

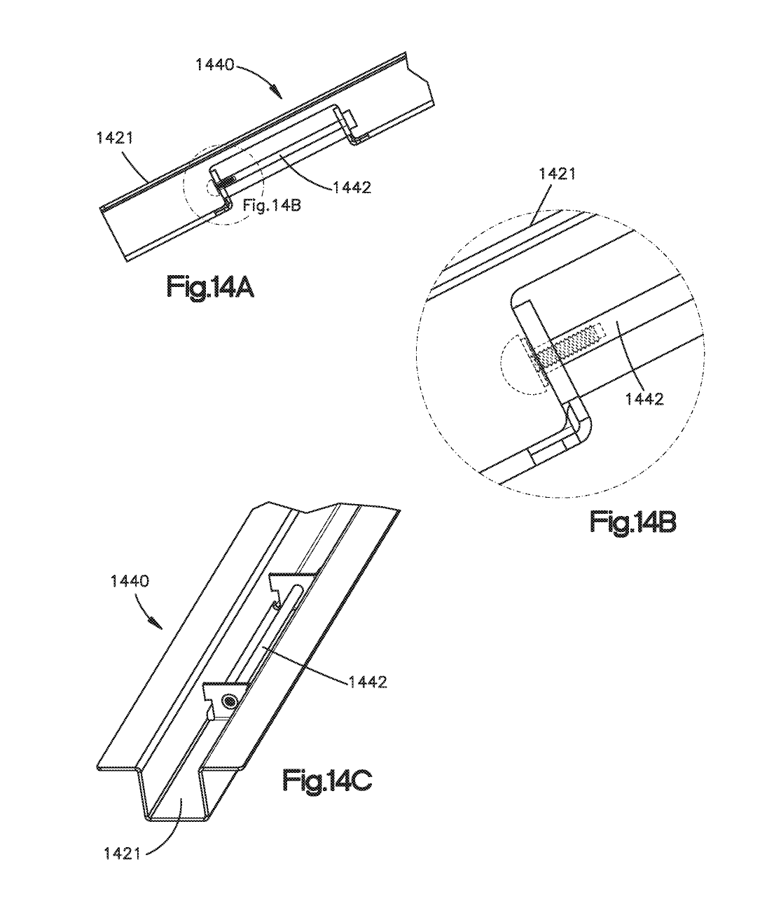

Note that in embodiments such as described herein, e.g., with reference to FIGS. 1A-13C, any suitable fastener can be used so as to mechanically and/or electrically couple a leg to a stiffener. For example, FIGS. 14A-14C schematically illustrate joint 1440 that includes a hinge pin that includes an internally threaded pin 1442 with a bolt 1445 in the end, such as an M5 fastener. Internally threaded pin can pass through first and second apertures defined through stiffener 1421 in a manner similar to that described herein with reference to FIGS. 3 and 4A-4B. Optionally, a washer (e.g., a serrated washer) can be provided between the head of the bolt and the first aperture in a manner such as illustrated in FIG. 14B.

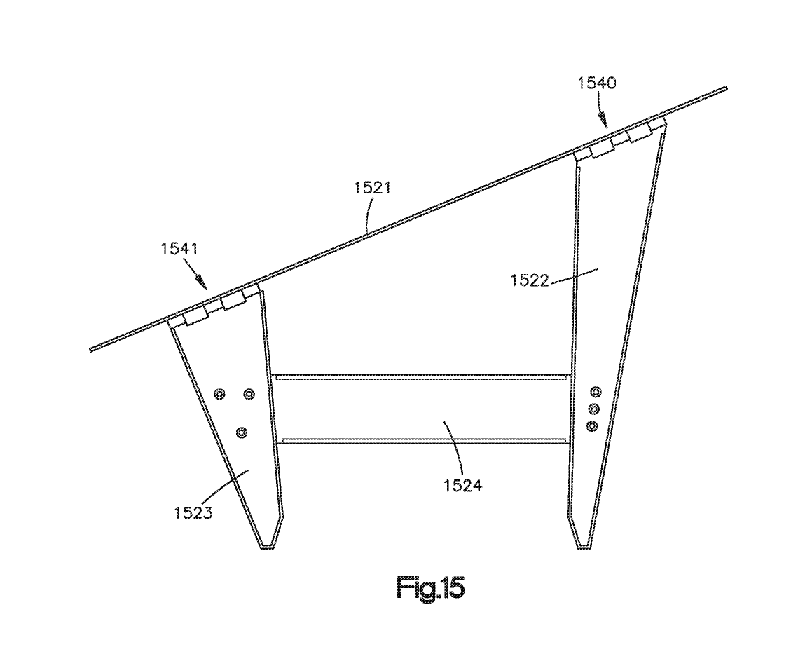

Additionally, it should be appreciated that any suitable type of hinge or joint can be used so as to mechanically and/or electrically join a leg to a stiffener. For example, FIG. 15 schematically illustrates a side view of exemplary joints 1540, 1541 between stiffener 1521 and respective legs 1522, 1523, wherein the joints include piano-style hinges. In some embodiments, stiffener 1521 includes a flat sheet stiffener with piano hinge knuckles formed in the center of the stiffener, and a hinge knuckle is formed in the end of each of legs 1522, 1523. Illustratively, the embodiment illustrated in FIG. 15 includes formed sheet metal stiffener 1521, hinges 1540, 1541, legs 1522, 1523, and cross-brace 1524. However, it should be appreciated that any suitable material or combination of materials can be used. Optionally, joints 1540, 1541 can include one or more electrical conductors, such as provided herein, so as to electrically bond stiffener 1521 to legs 1522, 1523 respectively. For example, joints 1540, 1541 respectively can include springs such as described herein with reference to FIGS. 11A-11B, metal straps such as described herein with reference to FIG. 12, or wires such as described herein with reference to FIGS. 13A-13B.

The systems and methods herein optionally can include additional structures that can facilitate electrical bonding between elements and/or management of cables. For example, FIGS. 16A-16E schematically illustrate different views of an exemplary structure for providing bonding and/or cable management within an exemplary system for mounting a photovoltaic module, according to some embodiments. FIGS. 16A and 16B respectively illustrate side and plan views of non-limiting system 1600 that include structures 1670, 1671 providing bonding and/or wire grounding to photovoltaic module 1610 and optionally also or alternatively management of electrical cables 1672 which cables can connect photovoltaic module 1610 to junction box 1613 and/or to other photovoltaic modules and/or to a power station. For example, structures 1670, 1671 can include bonding/wire management assemblies respectively connecting stiffeners 1621, 1621′ to photovoltaic panel frame 1612 and also suspending cables/wires 1672. As shown in FIGS. 16C and 16D, structure 1670 can include clamping attachment 1673 to module frame 1612, plenum 1674 for holding electrical cables 1672, and connection 1675 to stiffener 1621, e.g., using either bolts, rivets, welding, or other mechanical means. Structure 1671 can be configured similarly as structure 1670. FIG. 16E illustrates an exemplary alternative structure 1670′ connecting photovoltaic module frame 1612 to stiffener 1621.

As described above, such as with reference to FIGS. 1A-1D, the present systems and methods for mounting a photovoltaic module, can include providing a suitable concrete ballast (rail) that can support one or more of the legs of the mounting system. Such concrete ballast optionally can include one or more features that can enhance mechanical stability of the photovoltaic modules mounted therein. As one example, a concrete ballast system for supporting a photovoltaic module can include a concrete rail that includes a plurality of at least partial cuts therethrough so as to provide a plurality of interlocking portions with reduced movement relative to one another. For example, FIG. 17A schematically illustrates selected features of an exemplary concrete rail within an exemplary system for mounting a photovoltaic module, according to some embodiments. Exemplary rail 1730 illustrated in FIG. 17A includes V-shaped control joint 1780 cut partially or entirely through the concrete, which control joint can provide controlled cracking of rail 1730, e.g., responsive to a seismic event or settling of the ground at the installation site. Separate pieces 1781, 1782 of concrete rail 1730 are interlocked with the V-shape so as to reduce or prevent movement relative to each other, e.g., so as to reduce or prevent lateral movement of pieces 1781, 1782 relative to one another, while permitting vertical movement of such pieces relative to one another. Illustratively, control joint 1781 can include at least a partial cut through the ballast concrete 1730 in a shallow “v” shape. However, it should be appreciated that control joint 1780 can have any suitable shape that partially or fully divides concrete rail 1730 into interlocking pieces 1781, 1782 in such a manner as to reduce or inhibit movement of pieces 1781, 1782 relative to each other, e.g., so as to reduce or prevent lateral movement of pieces 1781, 1782 relative to one another, while permitting vertical movement of such pieces relative to one another. For example, control joint 1780 can be arcuate, puzzle-piece-shaped, tongue-in-groove shaped, or any other suitable shape. In some embodiments, control joint 1780 extends between about 10% of the thickness to the entirety of the thickness of ballast 1730, e.g., extends between about ⅓ to ⅔ of the thickness of ballast 1730, e.g., extends between about ⅓ to ⅔ of the thickness of ballast 1730. Optionally, rail 1730 also can have features such as described herein with reference to FIGS. 1A-1D, e.g., can include first and second elongated grooves extending parallel to one another and parallel to the concrete rail. The photovoltaic module being mounted on rail 1730 can be coupled to first, second, third, and fourth legs each including a foot, the feet of the first and third legs being insertable into the first elongated groove and the feet of the second and fourth legs being insertable into the second elongated groove.

Additionally, or alternatively, a plurality of photovoltaic modules optionally can be supported along a particular concrete rail (concrete ballast) so as to average localized wind gusts over the rail. For example, FIGS. 17B-17C are plots illustrating selected characteristics of exemplary systems for mounting a photovoltaic module, according to some embodiments. FIG. 17B illustrates bending moments in a structurally continuous rail, where modules are mounted on the rail and subjected to wind loading. The numbered nodes correspond to module leg mounting locations. FIG. 17C illustrates that the design load factor decreases as the number of modules sharing a structurally continuous section of rail increases.

Accordingly, it should be understood that exemplary feature of the apparatus, systems, and methods for photovoltaic module mounting or for hinge pin grounding include one or more of the following:

A grounding path through a structural rotating hinge; and/or
Hinge pin utilized for bonding, structure, and leg deployment; and/or
Exemplary apparatus and methods to attain grounding/bonding path include one or more of the following
   Hinge pin and threadlocker (LOCTITE®);
   Mechanical locking grounding hinge;
   Welded fastener; and/or
   Interference fit
One or more of the following features:
   Bonding path;
   Structural component for mounting system;
   Hinge for stowed system to deploy; and/or
      Pin allows mounting system to stow inside module frame for packaging and shipping
   Grounding path through structural rotating hinge.

In one non-limiting example, a system is provided for mounting a photovoltaic module. The system can include first and second stiffeners each coupled to the photovoltaic module, and first, second, third, and fourth legs. The system also can include a first joint rotatably coupling the first leg to the first stiffener; a second joint rotatably coupling the second leg to the first stiffener; a third joint rotatably coupling the third leg to the second stiffener; and a fourth joint rotatably coupling the fourth leg to the second stiffener. The system also can include a first crossbrace fixedly coupling the first and second legs to one another; and a second crossbrace fixedly coupling the third and fourth legs to one another. The first and second legs respectively can be rotatable about the first and second joints from a stowed position to an open position supporting the photovoltaic module, and the third and fourth legs respectively can be rotatable about the third and fourth joints from a stowed position to an open position supporting the photovoltaic module. Exemplary embodiments of such a system are described herein, for example, with reference to FIGS. 1A-1D, 15, and 18A-18B.

In another non-limiting example, a concrete ballast system is provided for supporting a photovoltaic module. The concrete ballast system can include a concrete rail including a plurality of at least partial cuts therethrough so as to provide a plurality of interlocking portions with reduced movement relative to one another. Exemplary embodiments of such a system are described herein, for example, with reference to FIGS. 17A-17C.

In another non-limiting, a system is provided for supporting a photovoltaic module. The system can include a stiffener coupled to the photovoltaic module; a leg; a joint rotatably coupling the leg to the stiffener between a stowed position and an open position; and an electrical member electrically bonding the stiffener and the leg to one another in at least the open position. Exemplary embodiments of such a system are described herein, for example, with reference to FIGS. 1A-1D, 2, 3, 4A-4B, 5A-5B, 6, 7, 8A-8B, 9, 10, 11A-11B, 12, 13A-13C, 14A-14C, and 15.

While various illustrative embodiments of the invention are described herein, it will be apparent to one skilled in the art that various changes and modifications may be made therein without departing from the invention. The appended claims are intended to cover all such changes and modifications that fall within the true spirit and scope of the invention.

1. A system for mounting a photovoltaic module, the system comprising:
first and second stiffeners each coupled to the photovoltaic module;
first, second, third, and fourth legs;
a first joint rotatably coupling the first leg to the first stiffener;
a second joint rotatably coupling the second leg to the first stiffener;
a third joint rotatably coupling the third leg to the second stiffener;
a fourth joint rotatably coupling the fourth leg to the second stiffener;
a first crossbrace fixedly coupling the first and second legs to one another; and
a second crossbrace fixedly coupling the third and fourth legs to one another;
the first and second legs respectively being rotatable about the first and second joints from a stowed position to an open position supporting the photovoltaic module,
the third and fourth legs respectively being rotatable about the third and fourth joints from a stowed position to an open position supporting the photovoltaic module.

2. The system of claim 1, wherein when the first, second, third, and fourth legs respectively are in the stowed positions, the first, second, third, and fourth legs each are folded flat against a back of the photovoltaic module.

3. The system of claim 1, wherein the photovoltaic module comprises a frame, and when the first, second, third, and fourth legs respectively are in the stowed positions, the first, second, third, and fourth legs each fit within the frame.

4. The system of claim 1, wherein when the first and second legs respectively are in the stowed position or in the open position, the first and second legs each extend at an acute angle of between about 50 degrees and about 90 degrees from the first stiffener, and
wherein when the third and fourth legs respectively are in the stowed position or in the open position, the third and fourth legs each extend at an acute angle of between about 50 degrees and about 90 degrees from the second stiffener.

5. The system of claim 1, wherein each of the first, second, third, and fourth legs comprises a respective foot,
the system further comprising a concrete ballast comprising first and second elongated grooves extending parallel to one another and parallel to the concrete ballast,
the feet of the first and third legs being insertable into the first elongated groove and the feet of the second and fourth legs being insertable into the second elongated groove when the first, second, third, and fourth legs respectively are in the open position.

6. The system of claim 5, wherein the foot of each of the first, second, third, and fourth legs comprises a tapered portion of the respective leg.

7. The system of claim 5, wherein the concrete ballast further comprises one or more interlocking control joints.

8. The system of claim 5, wherein a plurality of photovoltaic modules are mounted along the concrete ballast.

9. The system of claim 1, further comprising adhesive coupling the first and second stiffeners to the photovoltaic module.

10. The system of claim 9, wherein the adhesive comprises silicone adhesive, a first foam pad, and a second foam pad,
the first foam pad providing a first space between the first stiffener and the photovoltaic module,
the second foam pad providing a second space between the second stiffener and the photovoltaic module,
the silicone adhesive being disposed within the first space and the second space.

11. The system of claim 1, wherein each of the first, second, third, and fourth joints comprises a hinge pin extending through first and second apertures defined through the respective stiffener and extending through third and fourth apertures defined through the respective leg.

12. The system of claim 11, wherein at least one of the first, second, third, and fourth joints further comprises an electrical conductor disposed between and coupled to each of the respective stiffener and the respective leg.

13. The system of claim 12, wherein the electrical conductor is routed around the hinge pin.

14. The system of claim 12, wherein the conductor comprises a spring that forces the respective leg into the open position.

15. The system of claim 12, wherein the electrical conductor comprises a sheet metal strap.

16. The system of claim 12, wherein the electrical conductor comprises a wire.

17. The system of claim 16, wherein the hinge pin comprises a portion of the wire.

18. The system of claim 11, wherein at least one hinge pin comprises a shoulder bolt comprising a shoulder having a first diameter and a threaded portion having a second diameter that is smaller than the first diameter,
each joint further comprising a nut threaded on the threaded portion of the respective hinge pin, the nut clamping the respective leg against the respective stiffener so as to provide an electrical connection between that leg and that stiffener.

19. The system of claim 18, wherein the nut is sufficiently tightened so as to provide a predetermined amount of torque.

20. The system of claim 18, further comprising threadlocker disposed on the threaded portion of the hinge pin and inhibiting unlocking of the nut.

21. The system of claim 1, further comprising an electrical conductor comprising a wire with sufficient stiffness to force the respective leg into the open position.

22. The system of claim 1, further comprising an electrical conductor disposed between and coupled to the photovoltaic module and the first stiffener.

23. The system of claim 22, the electrical conductor disposed between and coupled to the photovoltaic module and the first stiffener being configured to support cables underneath the photovoltaic module.

24. The system of claim 1, wherein the first stiffener comprises one or more tool access holes for accessing the first joint.

25. The system of claim 1, wherein the first stiffener comprises a lance bridge for inhibiting rotation of the first leg past a preselected angle.

26.-53. (canceled)
